(19) United States
(12) Patent Application Publication
(10) Pub. No.: US 2026/0316498 A1
(43) Pub. Date: Oct. 15, 2026

(54) HITCH PIN MECHANISM

(71) Applicant: Gary Schein, Oxnard, CA (US)

(72) Inventor: Gary Schein, Oxnard, CA (US)

(21) Appl. No.: 19/174,243

(22) Filed: Apr. 9, 2025

(51) Int. Cl. B60D 1/02; B60D 1/52

(52) U.S. Cl. CPC B60D 1/025; B60D 1/52

(57) ABSTRACT

A hitch pin mechanism for attaching to a receiver tube of a hitch, such as a vehicle hitch that is attached to a vehicle, and for quickly and easily coupling the receiver tube to a secondary receiver hitch, such as found on a trailer. The hitch pin mechanism can be installed onto the exterior of the receiver tube of a hitch in a variety of orientations making it compatible to a variety of hitch configurations. A hitch pin of the hitch pin mechanism can be placed in a retracted position, after which the mechanism is attached to the receiver tube, and the hitch pin is then placed in its extended position. In its extended position, the distal portion of the hitch pin extends through the receiver tube and the secondary receiver hitch. The hitch pin can be locked into its extended position using a locking pin.

### BACKGROUND

Generally, vehicles utilize hitches for attaching a trailer, another vehicle, or other object for towing behind a tow vehicle or attaching a cargo holder to the front or back of the vehicle. In addition, hitches are used on bicycle racks and other devices. Typical hitches comprise a loose hitch pin that is not attached to the hitch and that is inserted through holes in a receiver tube of the hitch and holes in a secondary receiver hitch attached to the object being towed or a cargo holder. It can be difficult to properly align the holes in the hitch receiver tube and secondary receiver hitch to slide the hitch pin therethrough. The hitch pin may be inserted into the hole of the receiver hitch and the secondary receiver hitch, moved by hand or by moving the vehicle until they are aligned. Further, many hitches are coupled simply by a hitch pin and a securing pin preventing the hitch pin from rattling loose.

### SUMMARY

The hitch pin mechanism implementations described herein generally involve a mechanism that attaches a receiver tube of a hitch to a secondary receiver hitch. In one implementation, the hitch pin mechanism releasably attaches to a receiver tube of a hitch and releasably couples the hitch to a secondary receiver hitch. This hitch pin mechanism implementation includes a mounting bracket that has a receiver tube interface section and a hitch pin housing section. The receiver tube interface section includes proximal and distal end walls each of which is connected at one side by a side wall to form a structure with an open interior. The receiver tube interface section is sized to facilitate installation onto the exterior of the receiver tube of the hitch such that the side wall of the receiver tube interface section is disposed adjacent an upper or lower surface of the receiver tube and a pair of coaxial through holes in opposing sidewalls of the receiver tube are coaxially aligned with a hitch pin through hole in the proximal end wall of the receiver tube interface section. The hitch pin housing section includes proximal and distal end walls each of which is connected at one side by a first side wall and at the other side to a second side wall to form a structure with an open interior. The proximal and distal end walls of the hitch pin housing section each have a coaxial hitch pin through hole that is also coaxial with the hitch pin through hole in the proximal end wall of the receiver tube interface section. The hitch pin mechanism also includes a hitch pin. The hitch pin has a distal portion and a proximal portion and is installed in the mounting bracket such that the hitch pin extends distal end first through the coaxial hitch pin through hole of the distal end wall of the hitch pin housing section and at least partially through a passage formed by the coaxial hitch pin through hole of the proximal end wall of the hitch pin housing section and the coaxial hitch pin through hole in the proximal end wall of the receiver tube interface section. Whenever the hitch pin mechanism is in a retracted position, the distal end of the hitch pin is prevented from extending into the open interior of the receiver tube interface section via a hitch pin retainer that is attached to the proximal portion of the hitch pin and comprises a restraint section which is held within a hitch pin retainer retraction notch formed in the first or second side wall of the hitch pin housing section. Whenever the hitch pin mechanism is in an extended position, the distal end of the hitch pin extends into the open interior of the receiver tube interface section a distance sufficient for the distal portion of the hitch pin to extend through the pair of coaxial through holes in the opposing sidewalls of the receiver tube whenever the receiver tube interface section is installed on the receiver tube.

In another implementation, the hitch pin mechanism additionally includes a cylindrical compression coil hitch pin spring that surrounds the exterior of the proximal portion of the hitch pin. This hitch spring is capable of compressing to a length no more than the distance between an interior facing side of the distal end wall of the hitch pin housing section and the hitch pin retainer retraction notch. In addition, this hitch spring is capable of extending to a distance that is at least as long as the distance between the interior facing side of the distal end wall of the hitch pin housing section and the interior facing side of the proximal end wall of the hitch pin housing section. Whenever the hitch pin mechanism is in the retracted position, the hitch pin spring is compressed between the shank portion of the hitch pin retainer and the interior facing side of the distal end wall of the hitch pin housing section. Whenever the shank section of the hitch pin retainer is removed from the hitch pin retainer retraction notch when the hitch pin mechanism is in the retracted position, the hitch pin spring exerts a force on the hitch pin retainer which at least assists in pushing the hitch pin until the hitch pin mechanism is in the extended position.

In yet another implementation, the hitch pin of the hitch pin mechanism is a cylindrical hitch pin having a threaded distal portion with threads that mate with at least one threaded through hole in the opposing sidewalls of a hitch's receiver tube and a secondary receiver hitch, and a smooth proximal portion which is installed in the mounting bracket such that the hitch pin extends distal end first through the coaxial hitch pin through hole of the distal end wall of the hitch pin housing section and at least partially through a passage formed by the coaxial hitch pin through hole of the proximal end wall of the hitch pin housing section and the coaxial hitch pin through hole in the proximal end wall of the receiver tube interface section. Whenever the hitch pin mechanism is in a retracted position, the distal end of the hitch pin does not extend into the open interior of the receiver tube interface section, and whenever the hitch pin mechanism is placed in an extended position, the distal end of the hitch pin is rotated so as to extend into the interior of the receiver tube interface section a distance sufficient for the distal portion of the hitch pin to extend through a pair of coaxial through holes in the opposing sidewalls of the receiver tube and secondary receiver hitch whenever the receiver tube interface section is installed on the receiver tube.

The foregoing Summary is provided to introduce a selection of concepts, in a simplified form, that are further described hereafter in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more detailed description that is presented below.

### DESCRIPTION OF THE DRAWINGS

The specific features, aspects, and advantages of the hitch pin mechanism implementations described herein will become better understood with regard to the following description, appended claims, and accompanying drawings where:

FIGS. 1A-B are diagrams illustrating perspective top views, in simplified form, of an exemplary implementation of the hitch pin mechanism in its extended (FIG. 1A) and retracted (FIG. 1B) positions.

FIGS. 2A-B are diagrams illustrating perspective top views, in simplified form, of an exemplary implementation of the mounting bracket of the hitch pin mechanism.

FIGS. 3A-B are diagrams illustrating perspective views, in simplified form, of an exemplary implementation of the mounting bracket of the hitch pin mechanism with a reinforcing sleeve that conforms to the shape of and is secured to the interior facing surfaces of the receiver tube interface section.

FIG. 4 is a diagram illustrating a perspective top view, in simplified form, of an exemplary implementation of the hitch pin of the hitch pin mechanism.

FIG. 5 is a diagram illustrating a perspective top view, in simplified form, of an exemplary implementation of the hitch pin spring of the hitch pin mechanism.

FIG. 6 is a diagram illustrating a perspective top view, in simplified form, of an exemplary implementation of the hitch pin retainer of the hitch pin mechanism.

FIGS. 7A-D are diagrams illustrating perspective top views, in simplified form, of an exemplary implementation of the hitch pin mechanism in its retracted position installed in various orientations on the receiver tube of a hitch attached to the rear of a vehicle.

FIGS. 8A-B are diagrams illustrating perspective top views, in simplified form, of an exemplary implementation of the hitch pin mechanism, without a hitch pin spring, in its extended (FIG. 8A) and retracted (FIG. 8B) positions.

FIGS. 9A-B are diagrams illustrating perspective top views, in simplified form, of an exemplary implementation of the hitch pin mechanism in its retracted position installed on the receiver tube of a hitch attached to the rear of a vehicle (FIG. 9A) and in its extended position with a secondary receiver hitch installed in the receiver tube (FIG. 9B).

FIG. 10 is a diagram illustrating a perspective top view, in simplified form, of an exemplary implementation of the hitch pin mechanism in its extended position with a locking pin installed in its hitch pin.

FIG. 11 is a diagram illustrating a side view, in simplified form, of an exemplary implementation of an alternate locking pin.

FIG. 12 is a diagram illustrating a perspective top view, in simplified form, of an exemplary implementation of the hitch pin mechanism in its extended position with the alternate locking pin installed in its hitch pin.

FIG. 13 is a diagram illustrating a perspective top view, in simplified form, of an exemplary implementation of the hitch pin mechanism in its extended position with a partially threaded hitch pin.

FIG. 14A-B is a diagram illustrating a perspective top view, in simplified form, of an exemplary implementation of the hitch pin mechanism in its retracted position with a partially threaded hitch pin (FIG. 14A) and a perspective top view, in simplified form, of an exemplary implementation of a spacer that is installed in the hitch pin through holes (FIG. 14B).

FIG. 15 is a diagram illustrating a perspective top view, in simplified form, of an exemplary implementation of the hitch pin mechanism in its extended position with a pressure plate attachment apparatus having two swivel-tip screws used for attaching the hitch pin mechanism to the receiver tube of a hitch.

FIG. 16 is a diagram illustrating a perspective top view, in simplified form, of an exemplary implementation of the hitch pin mechanism in its extended position with a pressure plate attachment apparatus having one swivel-tip screw used for attaching the hitch pin mechanism to the receiver tube of a hitch.

FIG. 17 is a diagram illustrating a perspective top view, in simplified form, of an exemplary implementation of the mounting bracket of the hitch pin mechanism with a section removed from the upper side wall of the hitch pin housing section.

FIG. 18 is a diagram illustrating a perspective top view, in simplified form, of an exemplary implementation of the mounting bracket of the hitch pin mechanism with a section removed from the lower side wall of the hitch pin housing section.

FIGS. 19A-G are diagrams illustrating various views, in simplified form, of an exemplary implementation of a hinged strap assembly incorporated into the receiver tube interface section of the hitch pin mechanism. FIG. 19A shows a perspective top view the mounting bracket with the hinged strap in its open position. FIG. 19B is a perspective view of the hinged strap of the hinged strap assembly. FIG. 19C shows a perspective top view the mounting bracket with the hinged strap in its closed position. FIG. 19D is a top view of one version of the receiving apparatus of the hinged strap assembly. FIG. 19E is a side view of the version of the receiving apparatus of the hinged strap assembly shown in FIG. 19D. FIG. 19F is a top view of a second version of the receiving apparatus of the hinged strap assembly. FIG. 19G is a side view of the second version of the receiving apparatus of the hinged strap assembly shown in FIG. 19F.

FIG. 20 is a diagram illustrating a partial perspective top view, in simplified form, of an exemplary implementation of the hitch pin mechanism with an attachment apparatus having a rectangular retaining plate forming the distal end wall of the receiver tube interface section of the hitch pin mechanism.

FIGS. 21A-B are diagrams illustrating views, in simplified form, of an exemplary implementation of an alternate hitch pin retainer in the form of a single lobe disk cam. FIG. 21A is a back view and FIG. 21B is a side view.

FIGS. 22A-B are diagrams illustrating views, in simplified form, of an exemplary implementation of an alternate hitch pin retainer in the form of a double lobe disk cam. FIG. 22A is a back view and FIG. 22B is a side view.

FIG. 23 is a diagram illustrating a side view, in simplified form, of an exemplary implementation of the alternate hitch pin retainer in the form of a double lobe disk cam installed on the hitch pin of the hitch pin mechanism.

FIG. 24 is a diagram illustrating a perspective top view, in simplified form, of an exemplary implementation of the hitch pin mechanism in its extended position with the alternate hitch pin retainer in the form of a single lobe disk cam installed on the hitch pin.

FIG. 25 is a diagram illustrating a perspective top view, in simplified form, of an exemplary implementation of the hitch pin mechanism in its retracted position with the alternate hitch pin retainer in the form of a single lobe disk cam installed on the hitch pin.

FIG. 26 is a diagram illustrating a perspective top view, in simplified form, of an exemplary implementation of the hitch pin mechanism in its retracted position with the alternate hitch pin retainer in the form of a double lobe disk cam installed on the hitch pin.

### DETAILED DESCRIPTION

In the following description of the hitch pin mechanisms reference is made to the accompanying drawings which form a part hereof, and in which are shown, by way of illustration, specific implementations in which the hitch pin mechanism can be practiced. It is understood that other implementations can be utilized and structural changes can be made without departing from the scope of the hitch pin mechanism.

It is also noted that for the sake of clarity specific terminology will be resorted to in describing the hitch pin mechanism implementations and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation” means that a particular feature, a particular structure, or particular characteristics described in connection with the implementation or implementation can be included in at least one implementation of the hitch pin mechanism. The appearances of the phrases “in one implementation”, “in another implementation”, “in an exemplary implementation”, “in an alternate implementation”, “in one implementation”, “in another implementation”, “in an exemplary implementation”, and “in an alternate implementation” in various places in the specification are not necessarily all referring to the same implementation or implementation, nor are separate or alternative implementations/implementations mutually exclusive of other implementations/implementations. Yet furthermore, the order of process flow representing one or more implementations or implementations of the hitch pin mechanism does not inherently indicate any particular order nor imply any limitations of the hitch pin mechanism.

Furthermore, to the extent that the terms “includes,” “including,” “has,” “contains,” variants thereof, and other similar words are used in either this detailed description or the claims, these terms are intended to be inclusive, in a manner similar to the term “comprising”, as an open transition word without precluding any additional or other elements. In addition, use of directional terms such as “upper,” “lower,”, “top”, “bottom”, “above,” “below”, “front”, “forward”, “aft”, “left”, “right”, longitudinal, lateral, proximal or distal, and etc. are intended merely for orientation, to describe the positions and/or orientations of various components of the invention relative to one another as shown in the figures, and are not intended to impose limitations on any position and/or orientation of any implementation of the invention relative to any reference point external to the reference.

### 1.0 Hitch Pin Mechanism

The hitch pin mechanism implementations described herein attach to a receiver hitch of a hitch, such as a vehicle hitch that is attached to a vehicle and are used to quickly and easily couple the receiver hitch to a secondary receiver hitch. The vehicle may be a car, truck, tractor, or commercial vehicle that is used to tow a trailer, or another vehicle, or any other mobile load. The secondary receiver hitch can be a rear receiver hitch or bumper hitch, such as a trailer ball mount that is attached to a trailer that is towed by the vehicle. Alternately, the secondary receiver hitch can be a front or rear mounting hitch that attaches a cargo holder (e.g., a luggage rack or bicycle rack) to the front or rear of a vehicle. Further, the hitch need not be a vehicle hitch. Rather the hitch can be attached to a stationary object, and the secondary receiver hitch can be attached to a trailer of some other object that is secured to the stationary object via the hitch connection.

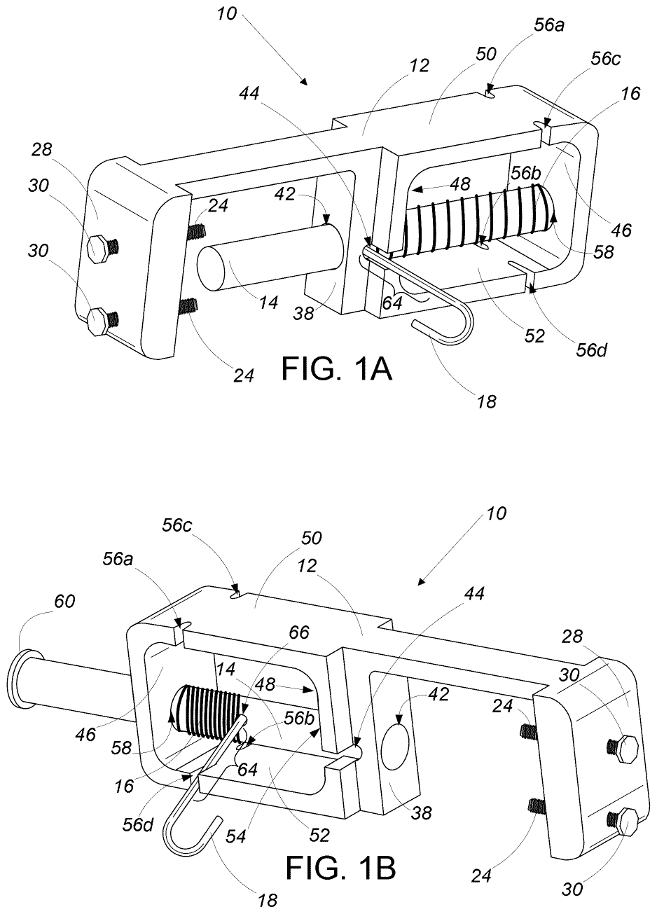

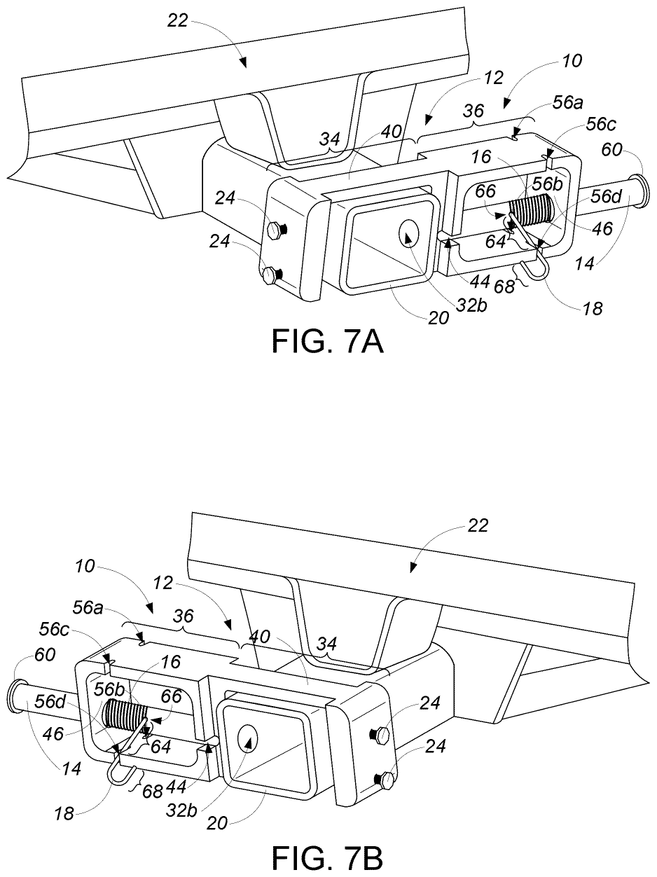

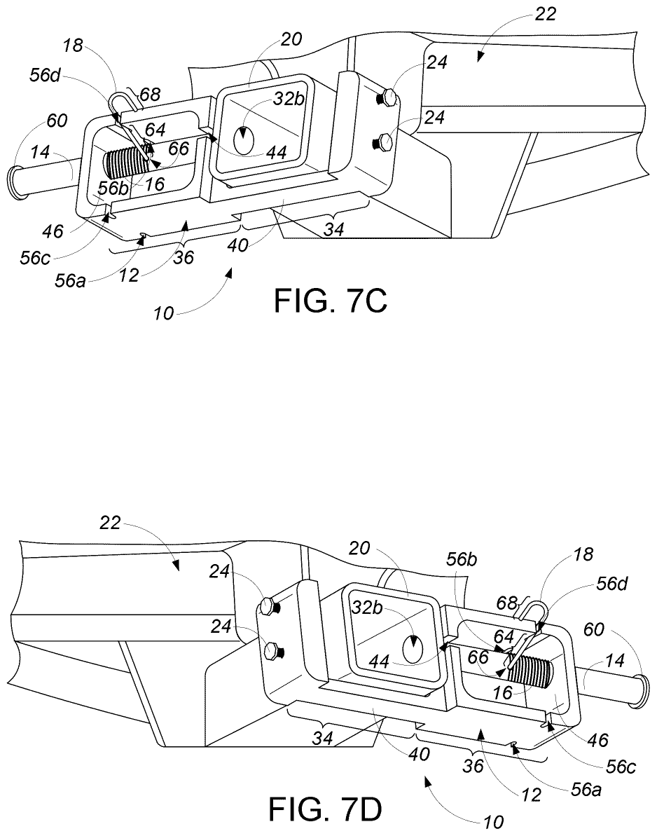

FIGS. 1A-B depict one implementation of a hitch pin mechanism 10, which generally includes a mounting bracket 12, a hitch pin 14, a hitch pin spring 16, and a hitch pin retainer 18. As can be best seen in FIGS. 7A-D, the mounting bracket 12 includes an attachment apparatus that is used to attach the mounting bracket to the exterior of the receiver tube 20 of a hitch 22. The receiver tube 20 has a left hitch pin through hole 32a and a coaxial right hitch pin through hole 32b through which the hitch pin can pass, as will be described in more detail in sections to follow.

### 1.1 Mounting Bracket

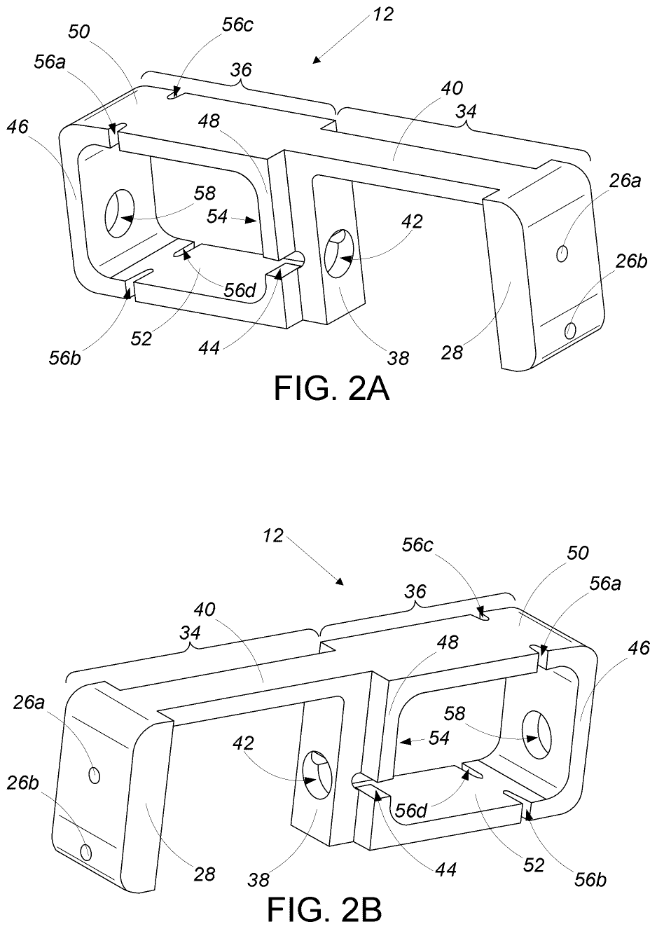

FIGS. 2A-B depict one implementation of the mounting bracket 12 that generally includes a receiver tube interface section 34 and a hitch pin housing section 36. It is noted that these sections 34, 36 can be separate structures that are connected together to form the mounting bracket 12, or they can be formed as a single unitary piece.

### 1.1.1 Receiver Tube Interface Section

The receiver tube interface section 34 of the mounting bracket 12 implementation depicted in FIGS. 2A-B includes two laterally-oriented end walls, namely the distal end wall 28 and a proximal end wall 38. These end walls 28, 38 are parallel to each other and separated by a longitudinally-oriented side wall 40 that is attached at its ends to a different one of the end walls 28, 38 as shown in FIGS. 2A-B to form a three-sided structure with an open interior that is open at the side opposite the side wall 40, as well as at its inner and outer faces. The receiver tube interface section 34 is designed to fit onto the exterior of the receiver tube of a hitch and be secured thereto using an attachment apparatus, as will be described in more detail in a section to follow. As can be seen in FIGS. 2A-B, the side wall 40 is not as wide as the end wall 28, and is centered on the midline of the width of the end walls 28, 38. Referring to FIGS. 7A-D, this smaller width of the side wall 40 is advantageous as it allows the side wall to clear any structures that are often found on the top or bottom of the receiver tube 20 of a hitch 22 (such as a rim at the rearward facing end of the receiver tube or a support bracket attached toward the rear of the receiver tube), while still allowing through holes associated with the mounting bracket 12 to line up with through holes in the receiver tube, as will be described shortly. Referring again to FIGS. 2A-B, the proximal end wall 38 includes a longitudinally-oriented hitch pin through hole 42 that is located approximately midway across the width of the proximal end wall 38, and located laterally such that when the side wall 40 is contacting the upper or lower exterior wall or the receiver tube, the hitch pin through hole 42 is coaxial with the hitch pin through holes located on the left and right sides of the receiver tube. The proximal end wall 38 also includes a distal portion of a hitch pin retainer slot 44 whose proximal portion is located in the hitch pin housing section 36 (as will be described in more detail in a section to follow). The distal portion of the hitch pin retainer slot 44 extends from the outer face of the receiver tube interface section 34 laterally inwards and opens up into the hitch pin through hole 42. It also extends longitudinally about halfway through the proximal end wall 38. The hitch pin retainer slot 44 acts as a guide channel for the hitch pin retainer as will be described in more detail in a section to follow.

Referring again to FIGS. 1A-B, in one implementation the aforementioned attachment apparatus takes the form of two threaded bolts 24. As best seen in FIGS. 2A-B, each of the threaded bolts is threaded through a different threaded through hole 26a, 26b in the laterally-oriented distal end wall 28 of the mounting bracket 12, with the bolt head 30 (see FIGS. 1A-B) on the exterior side of the mounting bracket. It is noted that while the bolt heads 30 shown in FIGS. 1A-B are hexagonal, this need not be the case. In alternate versions, the bolt heads can be round heads with a screwdriver slot, or a set screw with a slot for screwdriver or a hex wrench, or any other appropriate head type that allows the bolts to be rotated and tightened. The threaded through holes 26a, 26b are located approximately midway across the width of the mounting bracket's distal end wall 28. In addition, referring to FIGS. 7A-D, the threaded through holes 26a, 26b are separated from each other a sufficient distance that when the mounting bracket 12 is installed on the receiver tube 20 of the hitch 22, the distal ends of the threaded bolts 24 can be screwed against the side wall of the receiver tube on either side of the hitch pin through hole 32a (through which the hitch pin can pass as will be described shortly). Referring again to FIGS. 1A-B and 2A-B, it is also noted that the central axis of each threaded through hole 26a, 26b is parallel to the longitudinal axis of the mounting bracket 12 so that when the threaded bolts 24 are threaded through the threaded through holes they each extend into the mounting bracket along an axis that is parallel to the longitudinal axis of the mounting bracket.

In one version of the receiver tube interface section, the interior-facing surfaces of the distal and proximal end walls and the side wall are covered with a non-slip material (e.g., rubber or similar material) to inhibit the receiver tube of a hitch from slipping against the walls when installed in the receiver tube interface section. The aforementioned interior-facing surfaces of the receiver tube interface section can be coated with the non-slip material, or sheets of the material can be cut to fit and adhered to the interior surfaces of the walls.

### 1.1.2 Hitch Pin Housing Section

The hitch pin housing section 36 of the mounting bracket 12 implementation depicted in FIGS. 2A-B includes two laterally-oriented end walls, namely a distal end wall 46 and a proximal end wall 48. These end walls 46, 48 are parallel to each other and separated by upper and lower, longitudinally-oriented, side walls 50, 52 that are attached at their ends to a different one of the end walls 46, 48 as shown in FIGS. 2A-B to form a four-sided structure with an open interior. The hitch pin housing section 36 is designed as a supporting structure for the hitch pin 14 (as shown in FIGS. 1A-B). To this end, the proximal end wall 48 includes a longitudinally-oriented hitch pin through hole 54 that is connected to and coaxial with the longitudinally-oriented hitch pin through hole 42 of the receiver tube interface section 34. In addition, another longitudinally-oriented hitch pin through hole 58 is located in the distal end wall 46 of the hitch pin housing section 36. In one version, the diameter of these through holes 42, 54, 58 is the same and large enough to allow the hitch pin to slide back and forth through the holes in a longitudinal direction while at the same time minimizing movement of the hitch pin in non-longitudinal directions. In one version, a sliding fit between the hitch pin and the hitch pin through holes 42, 54, 58 is employed to achieve the desired movement. The proximal end wall 48 of the hitch pin housing section 36 further includes the proximal portion of the hitch pin retainer slot 44. The proximal portion of the hitch pin retainer slot 44 extends from the outer face of the hitch pin housing section 36 laterally inwards and opens up into the hitch pin through hole 54. It also extends longitudinally through the proximal end wall 48 and joins up with the distal portion of the hitch pin retainer slot 44 in the proximal end wall 38 of the receiver tube interface section 34. The depiction of the mounting bracket 12 in FIG. 2A shows a first face of the bracket, and the depiction of the mounting bracket 12 in FIG. 2B shows a second face of the bracket. It is noted that hitch pin retainer slot 44 formed into the first face of the mounting bracket 12 that is shown in FIG. 2A, is mirrored on the other face of the bracket. Consequently, a second hitch pin retainer slot 44 is formed into the second face of the mounting bracket 12, as shown in FIG. 2B.

Additionally, the hitch pin housing section 36 implementation depicted in FIGS. 1A-B and 2A-B includes four hitch pin retainer retraction notches 56a-d. The open end of the retraction notches 56a-d is located on the outer facing edge of a side wall 50, 52 and extends laterally into the side wall about one-quarter of its width. The notches 56a-d are wide enough to allow the shank portion 64 of the hitch pin retainer 18 to be inserted into the notch (as seen in FIG. 1B where the shank portion 64 is inserted into notch 56b). Each of the hitch pin retainer retraction notches 56a-d is also located a sufficient longitudinal distance from the distal end wall 46 of the hitch pin housing section 36 such that whenever the shank portion 64 of the hitch pin retainer 18 is installed in one of the notches, the hitch pin 14 is retracted to a position where its distal end is flush with the surface of the proximal end wall 38 of the receiver tube interface section 34 that faces the distal end wall 28 or is located within the hitch pin through holes 54, 42. The hitch pin retainer retraction notches 56a-d are indentions or a cut-outs, and can be configured with ninety-degree corners, or obtuse, or acute angles for securing the shank portion 64 of the hitch pin retainer 18.

### 1.1.3 Reinforcing Sleeve

The mounting bracket can be made from a variety of materials using a variety of manufacturing methods. For example, the mounting bracket can be formed, cast or machined from various metals, such as steel, stainless steel, aluminum, and so on.

The mounting bracket can also be formed, molded, printed, or machined from various plastic and fiber-reinforced plastic materials, such as, acetal, acrylic, nylon, fiberglass, carbon fiber reinforced plastic, and so on. However, no matter what material the mounting bracket is made from, the side wall of the receiver tube interface section must be stiff enough to resist flexing under the bending force applied to it when the pin hitch mechanism is installed on the receiver tube of a hitch and the threaded bolts are tightened down on the tube in order to prevent the hitch pin mechanism from coming loose from the receiver tube.

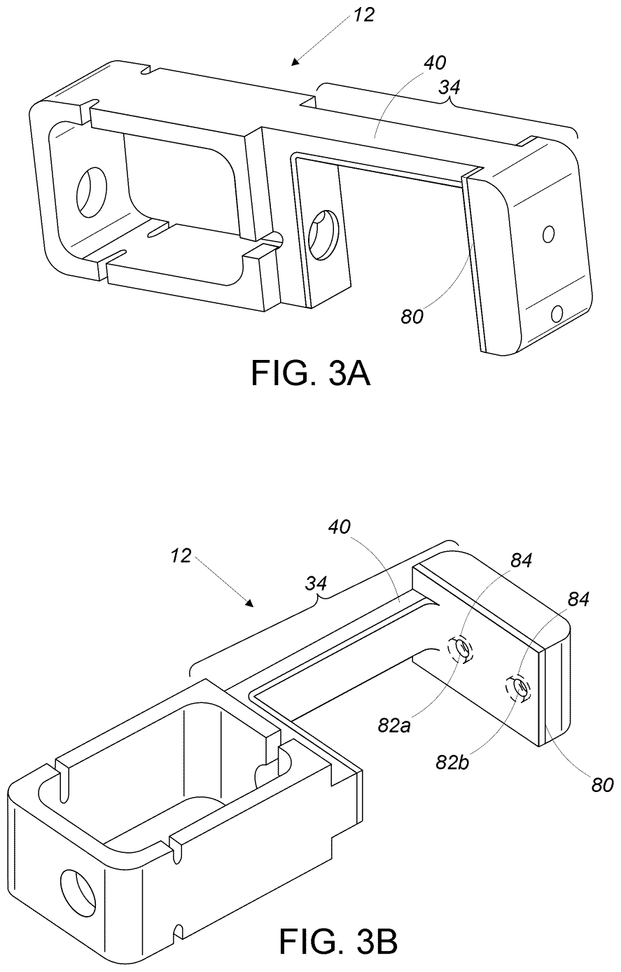

In one implementation of the hitch pin mechanism, shown in FIGS. 3A-B, a wider variety of materials can be used to manufacture the mounting bracket 12 even if they would be susceptible to the aforementioned flexing, by incorporating a reinforcing sleeve 80 that conforms to the shape of and is secured to the interior facing surfaces of the receiver tube interface section 34. The reinforcing sleeve 80 is made of strong, stiff material (e.g., steel, stainless steel, and so on) and has a thickness necessary to minimize the flexing of the side wall 40 of the receiver tube interface section 34 when the threaded bolts are tightened down on the tube. The side of the reinforcing sleeve 80 laying adjacent the interior-facing surface of the distal end wall 28 of the receiver tube interface section 34 has through holes 82a, 82b that align with the through holes 26a, 26b of the receiver tube interface section. In one version, both the through holes 26a, 26b and the through holes 82a, 82b are threaded the match the threads of the threaded bolts 24. In another version, either of the through holes 26a, 26b and the through holes 82a, 82b are threaded the match the threads of the threaded bolts 24, but not both. And in yet another version, the through holes 26a, 26b may or may not be threaded, but the through holes 82a, 82b are not. Instead, a nut 84 (or similar threaded piece) matching the threads of the threaded bolts 24 is attached (e.g., welded, glued, and so on) to the interior-facing side of the reinforcing sleeve in alignment with each of the through holes 82a, 82b. In FIG. 3B, the nuts 84 are shown in broken lines to indicate their optional nature.

### 1.2 Hitch Pin

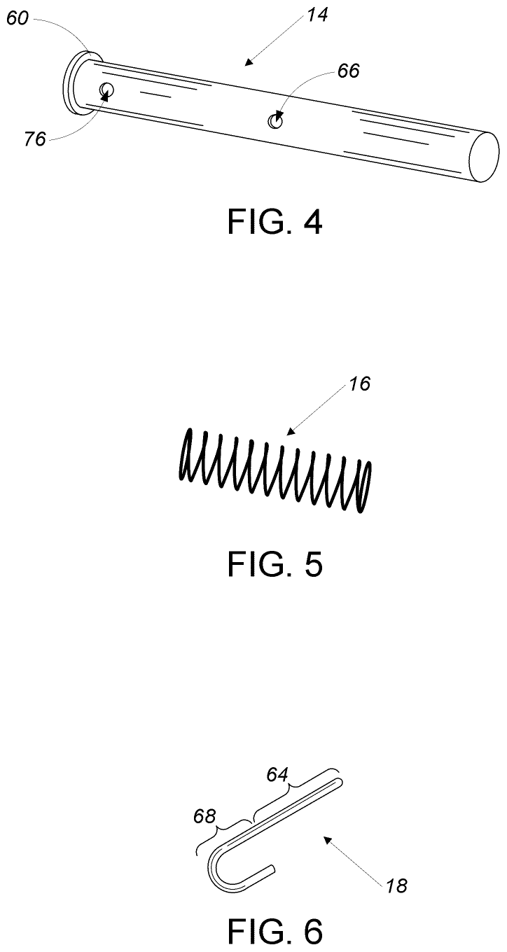

Referring to FIG. 4, in one implementation, the hitch pin 14 of the hitch pin mechanism is a cylindrical rod with a larger diameter disk-shaped head piece 60 at its proximal end. In alternate implementations, the head piece can be other shapes such as a hexagonal shape. However, the thickness of the head piece should be thin so that it does not interfere with other structures. For example, when the hitch is installed on the back end of a small vehicle, there is limited space for the hitch pin mechanism and so making the head piece of the hitch pin thin helps alleviate the space restrictions.

There are two through-holes that have parallel axes, each of which is perpendicular to and intersects the longitudinal axis of the hitch pin. The first through hole is the hitch pin's retainer through hole 66 and the second through hole is the locking pin through hole 76, both of which will be described in more detail in the sections to follow. In various implementations, the hitch pin 14 may be a standard ½-⅝ inch diameter. However, the hitch pin 14 may be any other custom size as needed. In addition, the hitch pin employed must be able to withstand a normal amount of shear force that may be imparted on it for the application it is employed. For example, if the hitch pin is being used in a hitch pin mechanism being employed to connect a vehicle hitch to a trailer, then the hitch pin must be able to withstand the shear force place on it when the vehicle is towing the trailer. It is noted that while the hitch pin 14 shown in FIG. 4 is cylindrical with a circular cross section, in other implementation, the hitch pin 14 cross section may be square, triangular, oval, or any other shape that may be useful.

### 1.3 Hitch Pin Spring

FIG. 5 depicts one implementation of the hitch pin spring 16. Referring to FIGS. 1A-B, the hitch pin spring 16 is a cylindrical compression coil spring that is designed to surround the exterior of the hitch pin 14 and is capable of compressing to a length no more than the distance between the interior facing side of the distal end wall 46 of the hitch pin housing section 36 and the hitch pin retainer retraction notches 56a-d, and to extend to a distance that is at least as long as the distance between the interior facing side of the distal end wall 46 of the hitch pin housing section 36 and the interior facing side of the proximal end wall 48 of the hitch pin housing section. The longitudinal spring force that the hitch pin spring 16 is capable of applying is chosen depending on the hitch pin extension and retraction methods employed and will be described in more detail in a section to follow.

### 1.4 Hitch Pin Retainer

FIG. 6 depicts one implementation of the hitch pin retainer 18. In this implementation, the hitch pin retainer is a crook-shaped cylindrical rod with the previously described shank section 64 and a finger handle portion 68. The uses for the hitch pin retainer will be described further in the sections to follow. It is noted that while the hitch pin retainer 18 depicted in the figures referenced throughout this description is formed from a cylindrical rod, this need not be the case. In other implementations, the hitch pin retainer can have cross-section shapes other than a circle. For example, in other implementations, the hitch pin retainer can have cross-sectional shapes such as a square, rectangle, triangle, oval, or in general any polygonal or irregular shape. Further the different sections of the hitch pin retainer can have cross-sectional shapes that are different from other sections of the retainer. Further, in one version, the hitch pin's retainer through hole is threaded and the hitch pin retainer's shank section is compatibly threaded. In this version, the hitch pin retainer is screwed into and out of the hitch pin's retainer through hole.

### 1.5 Hitch Pin Mechanism Extended and Retracted Positions

Referring again to FIGS. 1A-B, the hitch pin 14, hitch pin spring 16, and hitch pin retainer 18 are shown installed in the mounting bracket 12. In FIG. 1A, the hitch pin 14 is shown in its extended position, and in FIG. 1B, the hitch pin 14 is shown in its retracted position. In one version, the hitch pin is cylindrical, as shown in FIGS. 1A-B, and 4. In its extended position shown in FIG. 1A, the hitch pin 14 extends through the through hole 58 located in the distal end wall 46 of the hitch pin housing section 36, then through the through hole 54 located in the proximal end wall of the hitch pin housing section, and then through the through hole 42 located in the proximal end wall 38 of the receiver tube interface section 34. In one version, the hitch pin includes a disk-shaped head piece 60 located at its proximal end. The head piece 60 has a diameter that is larger than the through hole 58 located in the distal end wall 46 of the hitch pin housing section 36. In the extended position, the head piece 60 buts against the exterior facing surface of the distal end wall 46 of the hitch pin housing section 36 thereby dictating the distance the distal portion of the hitch pin 14 can extend past the through hole 42 located in the proximal end wall 38 of the receiver tube interface section 34. In one version, this distance is at least long enough for a distal portion of the hitch pin 14 to pass completely through the receiver tube of a hitch via its hitch pin through holes (e.g., 2-3⅝ inches). The hitch pin mechanism 10 can be configured to attach to standard one and one quarter, two inch, two and half inch, and three-inch receiver hitches, or otherwise any class 1-5 standard hitches where the measurement is the interior dimension of the receiver hitch. Alternately, the hitch pin mechanism 10 may be configured to attach to any size receiver hitch or may be custom manufactured. For example, hitch pin mechanism 10 can be sized to fit class I hitches with a 1¼ inch square receiver opening and weight carrying maximum gross trailer weight (GTW) of 2,000 pounds and 200 pound maximum trailer tongue weight (TW); class II hitches—2¼ inch square receiver hitch opening, 3,500 pound GTW, and 300 pound TW; class III hitches—2 inch square receiver opening, weight carrying 6,000 pound GTW, 600 pound TW, weight distributing 10,000 GTW and 1,000 TW; class IV—2 inch square receiver opening, weight carrying 10,000 pounds GTW and 1,000 pounds TW, weight distributing 14,000 pounds GTW and 1,400 pounds TW; and class V hitches at 2½ inch square receiver opening, weight carrying 12,000 GTW and 1,200 TW, weight distributing 17,000 pound GTW and 1,700 pound TW, or in general any hitch including custom sizes.

In one version, when the hitch pin 14 is in its extended position, the hitch pin spring 16, which surrounds the hitch pin, is fully extended. In this version, the hitch pin spring 16 may still be under some compression even if it is fully extended. In addition, when the hitch pin 14 is in its extended position, the hitch pin retainer 18, whose distal end of its shank portion 64 is installed in the hitch pin's retainer through hole 66, resides within the hitch pin retainer slot 44. It is noted that the hitch pin's retainer through hole 66 is located such that the hitch pin retainer 18 resides in the hitch pin retainer slot 44 but does not impinge on the end of the slot. This ensures the hitch pin 14 is fully extended to the point where the head piece 60 buts against the exterior facing surface of the distal end wall 46 of the hitch pin housing section 36. The reason some implementations have a hitch pin retainer slot is that larger hitch receiver tubes require the distal portion of the hitch pin to be long enough to extend completely through the receiver tube. When the hitch pin mechanism is in its fully retracted position, the proximal end of the hitch pin extends out of the distal end wall of the hitch pin housing section. Thus, a longer hitch pin extends out of the distal end wall further than a shorter one. However, some vehicles and other devices that employ hitches have limited room to accommodate the hitch pin mechanism. It was determined that the proximal end of a hitch pin designed to extend completely through the largest common receiver tubes would extend out of the distal end wall of the hitch pin housing section too far for some vehicles and other devices employing hitches. Thus, to accommodate the limited space available for the hitch pin mechanism on such vehicles and other devices, the previously described hitch pin retainer slot was added. The hitch pin retainer slot allows the hitch pin to extend further into the receiver tube interface section without extending further out of the distal end wall of the hitch pin housing section when the hitch pin mechanism is in its retracted position. Further, the diameter of the hitch pin's retainer through hole 66 and the diameter of the shank portion 64 of the non-threaded version of the hitch pin retainer 18 are chosen so that the hitch pin retainer can be readily removed by a user from the hitch pin's retainer through hole. To this end, a siding fit or locational clearance fit is employed. This is done so that the hitch pin retainer can be removed and stored when the mechanism is in its extended position, or to install it in one side or the other depending on the installation configuration as will be described shortly.

In its retracted position shown in FIG. 1B, the distal end of the hitch pin 14 is located in a position where it is flush with the surface of the proximal end wall 38 of the receiver tube interface section 34 that faces the distal end wall 28 or is located within the hitch pin through holes 54, 42, as described previously. The hitch pin 14 is held in this retracted position by the hitch pin retainer 18 whose shank portion 64 has been inserted into one of the hitch pin retainer retraction notches (e.g., hitch pin retainer retraction notch 56b as depicted in FIG. 1B). Additionally, when the hitch pin 14 is in its retracted position, the hitch pin spring 16 is fully compressed, with its proximal end butted against the distal end wall 46 of the hitch pin housing section 36 and its distal end held in place by the shank 64 of the hitch pin retainer 18.

### 1.6 Hitch Pin Mechanism Installation Orientations

The hitch pin mechanism 10 can be advantageously installed onto the exterior of the receiver tube 20 of a hitch 22 in a variety of orientations, as shown in FIGS. 7A-D. For example, as depicted in FIG. 7A, the hitch pin mechanism 10 can be installed on the receiver tube 20 such that the hitch pin housing section 36 is located adjacent the right of the receiver tube and the side wall 40 of the receiver tube interface section 34 is located on top of the receiver tube. Alternately, as depicted in FIG. 7B, the hitch pin mechanism 10 can be installed on the receiver tube 20 such that the hitch pin housing section 36 is located adjacent the left of the receiver tube and the side wall 40 of the receiver tube interface section 34 is located on top of the receiver tube. In another configuration, as depicted in FIG. 7C, the hitch pin mechanism 10 can be installed on the receiver tube 20 such that the hitch pin housing section 36 is located adjacent the right of the receiver tube and the side wall 40 of the receiver tube interface section 34 is located below the receiver tube. And, in yet another configuration, as depicted in FIG. 7D, the hitch pin mechanism 10 can be installed on the receiver tube 20 such that the hitch pin housing section 36 is located adjacent the left of the receiver tube and the side wall 40 of the receiver tube interface section 34 is located below the receiver tube. The installation configurations shown in FIGS. 7C and 7D, are possible due to the mirroring of the hitch pin retainer slot and hitch pin retainer retraction notches on both faces of the hitch pin mechanism, as described previously. The versatility of the installation configurations allows the hitch pin mechanism to be installed on a variety of different trailer hitches. For example, if a structural element of a hitch 22 attached to the bottom of the receiver tube 20 precludes the side wall 40 of the receiver tube interface section 34 of the hitch pin mechanism 10 from being placed on the bottom of the receiver tube, the hitch pin mechanism can be installed as shown in FIG. 7A or 7B with the side wall 40 of the receiver tube interface section 34 located above of the receiver tube. Alternately, if a structural element of a hitch 22 attached to the top of the receiver tube 20 precludes the side wall 40 of the receiver tube interface section 34 of the hitch pin mechanism 10 from being placed on top of the receiver tube, the hitch pin mechanism can be installed as shown in FIGS. 7C and 7D with the side wall 40 of the receiver tube interface section 34 located below of the receiver tube. Further, if a structural element of a hitch 22 or the structure/vehicle the hitch is attached to precludes the hitch pin housing section 36 of the hitch pin mechanism 10 from extending away from the receiver tube 20 to the right, the hitch pin mechanism can be installed with its hitch pin housing section extending to the left as shown in FIGS. 7A and 7C. If a structural element of a hitch 22 or the structure/vehicle the hitch it is attached to precludes the hitch pin housing section 36 of the hitch pin mechanism 10 from extending away from the receiver tube 20 to the left, the hitch pin mechanism can be installed with its hitch pin housing section extending to the right as shown in FIGS. 7B and 7D. Further, the hitch pin mechanism can advantageously remain coupled to the receiver tube of the hitch thus providing storage such that the hitch pin is not loose. Still further, the sideways installation of the hitch pin mechanism such that it does not extend past the end of the receiver tube of the hitch is advantageous. For example, the hitch attached to some vehicles is hidden by a covering panel. If the hitch pin mechanism is installed on the receiver tube of the hitch and it extends past the end of the receiver tube, it could interfere with the installation of the covering panel.

### 1.7 Hitch Pin Mechanism Operation

In operation, the hitch pin mechanism 10 is placed in its retracted position, if it is not already in that position, and then installed on the receiver tube 20 in the desired orientation (see FIGS. 7A-D). The hitch pin through hole 42 (see FIGS. 1A-B) of the receiver tube interface section 34 is lined up with the receiver tube hitch pin through holes 32a, 32b. This can be done visually with the hitch pin mechanism 10 in its retracted position, or more conveniently, the hitch pin 14 can be extended (as will be described shortly) while adjusting the position of the hitch pin mechanism until the hitch pin extends completely through the receiver tube 20. Once the hitch pin through hole 42 of the receiver tube interface section 34 is lined up with the receiver tube hitch pin through holes 32a, 32b, the threaded bolts 24 are screwed against the side wall of the receiver tube 20 on either side of a hitch pin through hole 32a and tightened to secure the hitch pin mechanism 10 to the receiver tube.

Once the hitch pin mechanism 10 is installed on the receiver tube 20, it can be in either its retracted or extended position. If the hitch pin mechanism 10 is in its extended position, and it is desired to place it in its retracted position, in one implementation, a user grasps the finger handle portion 68 of the hitch pin retainer 18 and pulls the hitch pin retainer toward the distal end wall 46 of the hitch pin housing section 36, thereby retracting the hitch pin 14 and compressing the hitch pin spring 16 longitudinally. When the user has pulled the hitch pin retainer 18 toward the distal end wall 46 far enough that shank portion 64 of the hitch pin retainer is aligned longitudinally with one of the hitch pin retainer retraction notches 56a-d, the user rotates the hitch pin using the finger handle portion 68 of the hitch pin retainer in either direction until the shank portion 64 is seated in one of the hitch pin retainer retraction notches 56a-d. This last action results in the hitch pin mechanism being secured in its retracted position.

If the hitch pin mechanism 10 is in its retracted position, and it is desired to place it in its extended position, in one implementation, the user grasps the finger handle portion 68 of the hitch pin retainer 18 and uses it to rotate the hitch pin 14 until the shank portion 64 of the hitch pin retainer is freed from the hitch pin retainer retraction notch it was seated in (e.g., hitch pin retainer retraction notch 56d as depicted in FIG. 7A). The user then guides the hitch pin into the receiver tube interface section 34 and through the receiver tube hitch pin through holes 32a, 32b. The hitch pin spring 16 will expand longitudinally as the hitch pin is extended, thereby assisting the user's action. However, it is noted that while the spring 16 advantageously assists the user in the hitch pin extension process, it is not essential to the procedure. As such, in one implementation of the hitch pin mechanism 10, the hitch pin spring is eliminated, as shown in FIGS. 8A-B. Toward the end of the extension procedure, the user rotates the hitch pin 14, if needed, so that the shank portion 64 of the hitch pin retainer 18 enters the hitch pin retainer slot 44. When the head piece 60 of the hitch pin 14 buts against the exterior facing surface of the distal end wall 46 of the hitch pin housing section 36, the hitch pin is fully extended, and the user can let go of the hitch pin retainer 18.

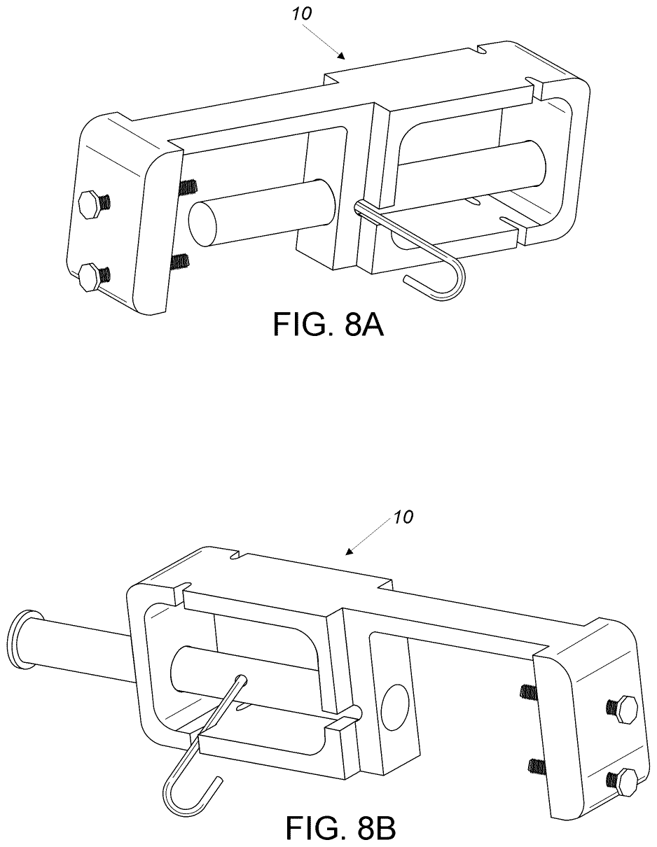

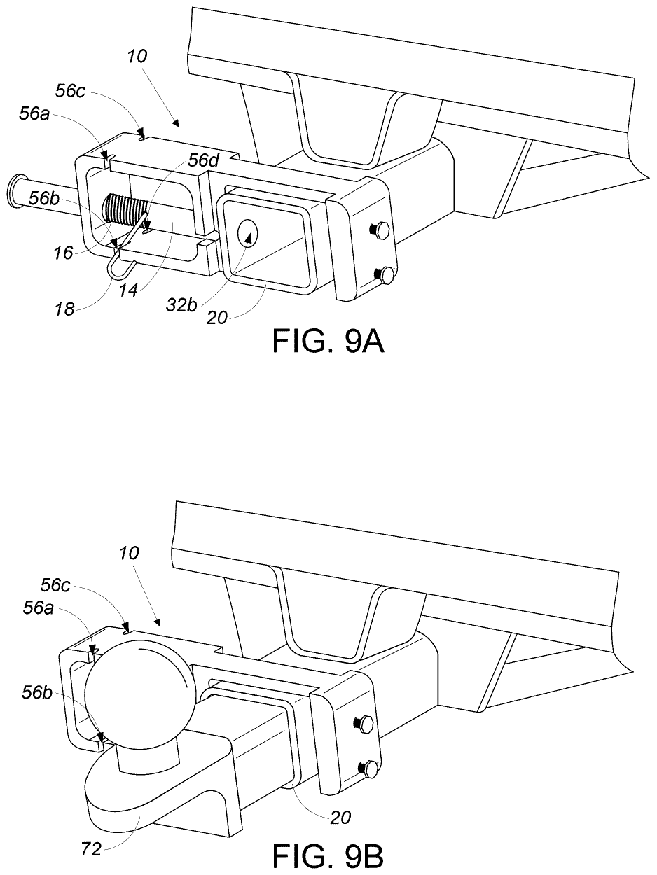

Referring to FIG. 9A-B, in a typical scenario, a secondary receiver hitch such as, for example, a trailer ball mount 72, is installed into the receiver tube. More particularly, as shown in FIG. 9A, with the hitch pin mechanism 10 installed on the receiver tube 20 as described previously and placed in its retracted position (in a manner described previously), if it is not already in that position, the hitch pin through holes 32a, 32b of the receiver tube 20 are aligned with hitch pin holes of the secondary receiver hitch (e.g., a trailer ball mount 72). The hitch pin mechanism 10 is then placed in its extended position (e.g., in one of the ways described previously), as shown in FIG. 9B. It is noted that the hitch pin will not only extend through the hitch pin through holes 32a, 32b of the receiver tube 20, but also through the hitch pin holes of the secondary receiver hitch thereby securing it into the receiver tube. It is further noted that if the hitch pin through holes 32a, 32b of the receiver tube 20 are not sufficiently aligned with the hitch pin holes of the secondary receiver hitch (e.g., the previously described ball mount), the hitch pin 14 may be blocked from extending through the secondary receiver hitch when the hitch pin retainer 18 is moved out of the hitch pin retainer retraction notch 56a-d and the hitch pin spring 16 pushes the hitch pin 14 forward. In such a case, the user can manipulate the position of the secondary receiver hitch until the through holes are aligned and the hitch pin 14 is free to extend through the secondary receiver hitch.

### 1.8 Locking Pin

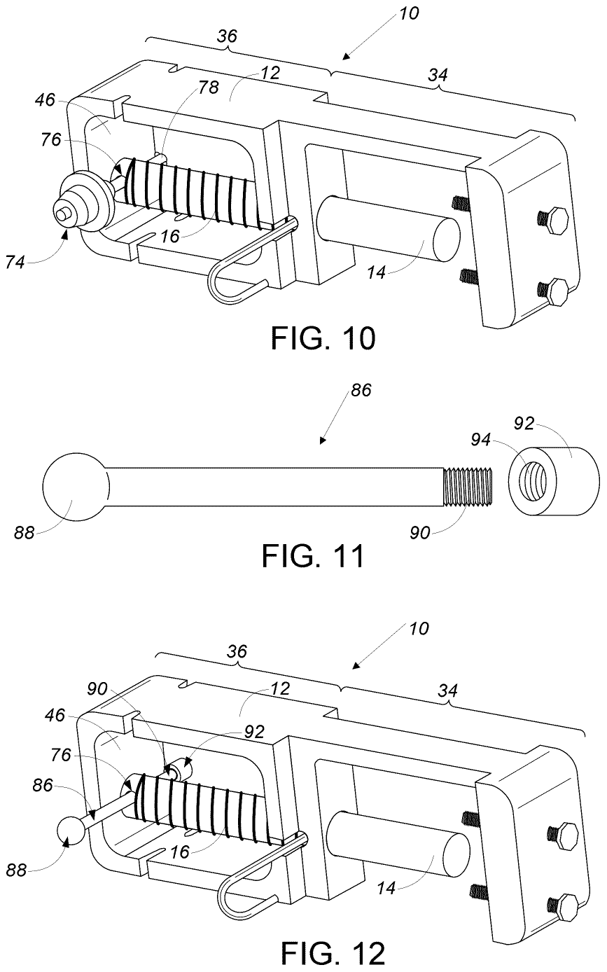

FIG. 10 depicts one implementation of the hitch pin mechanism 10 (with a hitch pin spring 16 installed) in its extended position. In this implementation, a locking pin 74 is installed in the previously described locking pin through hole 76. The looking pin 74 prevents the hitch pin 14 from retracting out of the receiver tube interface section 34 of the mounting bracket 12. To this end, the locking pin through hole 76 is located on the proximal portion of the hitch pin 14 such that when the hitch pin mechanism 10 is in its extended position and the head piece of the hitch pin 14 buts against the exterior facing surface of the distal end wall 46 of the hitch pin housing section 36, the locking pin through hole just clears the interior facing surface of the distal end wall. Thus, when the locking pin 74 is installed, its shaft 78 is in contact with the interior facing surface of the distal end wall 46 and prevents the hitch pin 14 from retracting. This is advantageous as it prevents the distal portion of the hitch pin 14 from backing out of the receiver tube of a hitch and accidentally releasing the secondary receiver hitch and whatever is attached to it (e.g., a trailer).

In the version of the hitch pin mechanism 10 depicted in FIG. 10, the locking pin 74 is a push button locking pin with a key lock, such as a M6 Locking Button Head Quick Release Ball Lock Pin, manufactured by Wuxi Ingks Metal Parts Co., Ltd. This type of locking pin is installed by inserting the locking pin shaft through the locking pin through hole when the locking pin is unlocked (i.e., the push button in the center of the locking pin head extends outward). Once the locking pin shaft is inserted, the user depresses the push button on the locking pin head to activate a locking mechanism located at the distal end of the locking pin shaft. The locking pin then cannot be removed without unlocking it again. The locking mechanism is deactivated using a key which is inserted into the locking pin head and rotated. This releases the push button which pops back out and the locking pin shaft can be removed from the locking pin through hole. Requiring a key to unlock the locking pin adds an extra measure of security to prevent tampering with the hitch pin mechanism and unauthorized retraction of the hitch pin.

However, the locking pin can be any pin that has a shaft long enough to traverse the locking pin through hole, such as a cotter pin, a bolt, or a screw. For example, in one version shown in FIG. 11, the locking pin 86 is a rod with a spherical end piece 88 on its proximal end and a threaded section 90 on its distal end. The spherical end piece 88 has a diameter that exceeds the diameter of the locking pin through hole (76 in FIG. 4). The locking pin 86 also includes a removable locking piece 92 with a blind hole 94 that has internal threads which match the threads of the threaded section 90 of the locking pin. The removable end piece 92 is also larger than the locking pin through hole (76 in FIG. 4). Referring now to FIG. 12, the locking pin 86 (as shown in FIG. 11) is installed by inserting the pin distal end first, without the removable locking piece 92 attached, through the locking pin through hole 76. The removable locking piece 92 is then threaded onto the threaded section 90 of the locking pin 86. With the removable locking piece 92 in place, the locking pin 86 cannot be removed from the locking pin through hole 76 without removing the locking piece.

### 2.0 Additional Implementations

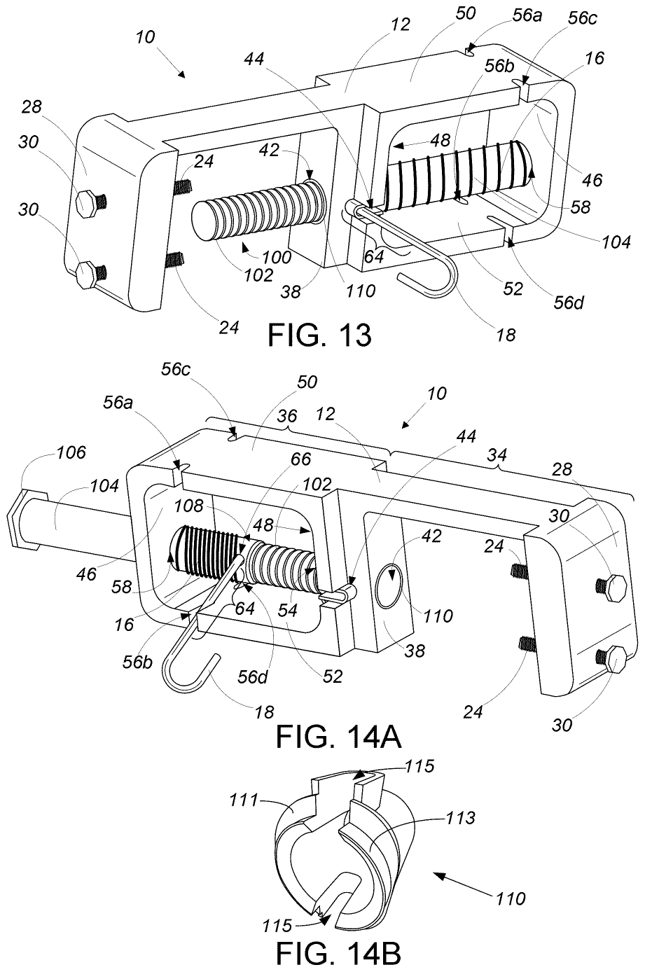

While the hitch pin mechanism has been described by specific reference to implementations thereof, it is understood that variations and modifications thereof can be made without departing from the true spirit and scope of the apparatus. For example, while the implementations of the hitch pin mechanism's hitch pin described previously indicated that the distal portion of the hitch pin has a smooth surface, this need not be the case. Certain hitches employ a receiver tube and a secondary receiver hitch in which at least one of the hitch pin through holes is threaded. For instance, some secondary receiver hitches that function as bike rack posts have one or more threaded hitch pin through holes. In such a case, referring to FIGS. 13 and 14A-B, an alternate implementation of the hitch pin 100 would be used that has compatible threading on the exterior of its threaded distal portion 102 and a smooth exterior portion 104 with a hex head 106 on its proximal end (or another means by which to turn the hitch pin such as round head with a screwdriver slot or a set screw with a slot for screwdriver or a hex wrench). It is noted that in one version the threaded hitch pin 100 has an abrupt transition 108 between its threaded distal portion 102 and its smooth proximal portion 104 that creates a radial wall at the transition. In addition, the threaded distal portion 102 of the hitch pin 100 has a smaller diameter than the smooth proximal portion 104 created by the threading process. As such, the threaded distal portion 102 of the hitch pin 100 would fit loosely in the hitch pin through holes 54, 42 and when the hitch pin is extended from its retracted position, this looseness can cause misalignment of the hitch pin with the receiver tube and a secondary receiver hitch through holes. To preclude this possibility, the threaded distal portion 102 of the hitch pin 100 is made long enough to at least extend through the hitch pin through holes 54, 42, as well as the receiver tube and a secondary receiver hitch through holes. In addition, a spacer 110 is installed in the hitch pin through holes 54, 42. The spacer 110 has an exterior diameter that fits snuggly into the hitch pin through holes 54, 42 and an interior diameter that forms a sliding fit with the threaded distal portion 102 of the hitch pin 100. The spacer 110 keeps the threaded distal portion 102 of the hitch pin 100 centered in the hitch pin through holes 54, 42 and precludes the aforementioned looseness. In one version shown in FIG. 14B, of the spacer 110 has a flange 111 with a diameter larger than the hitch pin through holes 54, 42 that abuts the interior facing side of the proximal end wall 48 of the hitch pin housing section 36 when the spacer is installed. This flange 111 assists in retaining the spacer 110 in the hitch pin through holes 54, 42. In addition, there is a lip 113 that extends outward from the flange 111 a short distance. This lip 113 forms a partial cylinder with a diameter slightly less than the interior diameter of the hitch pin spring 16. The lip 113 projects into the end of the hitch pin spring 16 when the spring is extended and keeps the spring from interfering with the threads of the threaded distal portion 102 of the hitch pin 100. It is also noted that there are slots 115 formed in the spacer 110 that line the hitch pin retainer slots 44 when the spacer is installed. In operation, the hitch pin would be extended as described previously to the point where its distal end encounters the first through hole of the receiver tube or secondary receiver hitch that has threads. The hitch pin retainer would then be removed and the hex head (or other type of head) at the proximal end of the hitch pin would be used to screw the hitch pin through the threaded through holes of the receiver tube and secondary receiver hitch until the head abuts the exterior surface of the hitch pin housing section's distal end wall (or if a set screw is employed until the proximal end of the hitch pin is flush with the exterior of the hitch pin housing section's distal end wall). It is noted that the transition 108 between the threaded distal portion 102 and the smooth proximal portion 104 of the hitch pin 100 is located such that the hitch pin head abuts the exterior surface of the hitch pin housing section's distal end wall (or if a set screw is employed until the proximal end of the hitch pin is flush with the exterior of the hitch pin housing section's distal end wall) before the transition 108 of the hitch pin 100 comes into contact with spacer 110. The hitch pin retainer would then be replaced into the hitch pin's retainer through hole. The hitch pin would be removed from the hitch by reversing the foregoing procedure.

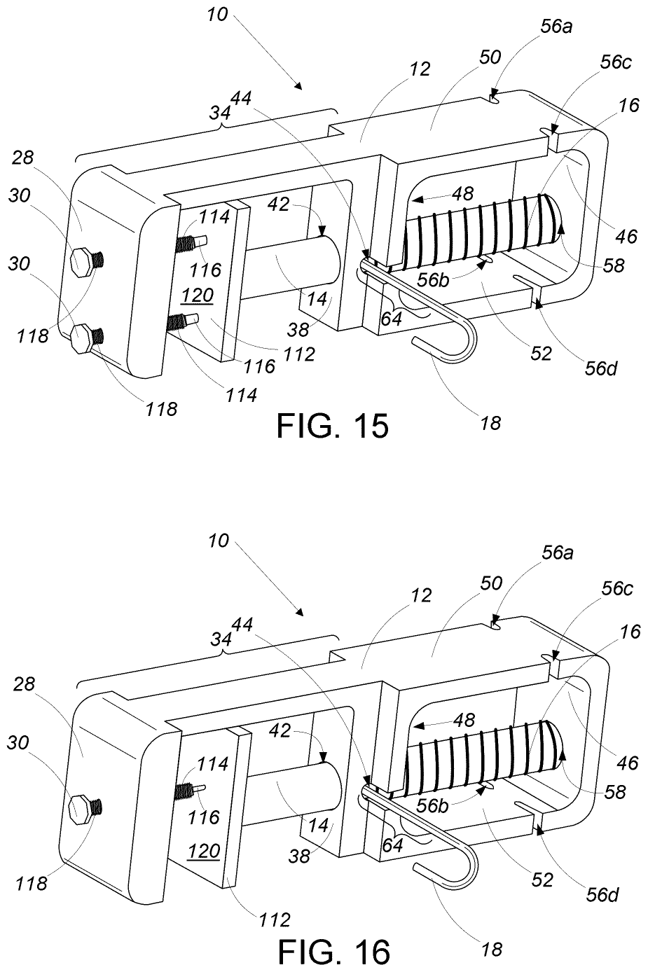

In one alternate implementation of the hitch pin mechanism illustrated in FIGS. 1A-B, a pressure plate 112 has been added as shown in FIG. 15 to protect the side of the receiver tube of the hitch from the ends of the threaded bolts (24 in FIGS. 1A-B) and to equalize the pressure placed on the receiver tube. The pressure plate 112 is a thin (e.g., ⅛ inch) rectangular plate having a length approximately the same as or slightly shorter that the vertical length of the interior facing side of the distal end wall 28 of the receiver tube interface section 34 and a width the same as or slightly shorter that the horizontal length of the interior facing side of the distal end wall 28 of the receiver tube interface section 34. The pressure plate 112 is made of strong, stiff material (such as steel, stainless steel, and so on). The threaded bolts 24 of the hitch pin mechanism 10 illustrated in FIGS. 1A-B have been replaced in the alternate implementation shown in FIG. 15 with swivel-tip screws 114. A swivel-tip screw 114 has a swivel tip 116 that is narrower than the threaded portion 118 of the screw so that it can pass through threaded holes during installation of the screw. For example, during construction of the hitch pin mechanism 10 shown in FIG. 15, the swivel-tip screws 114 are threaded into the threaded through holes 26a, 26b of the distal end wall 28 of the receiver tube interface section 34 an equal distance such that they extend into the interior of the section a prescribed distance (e.g., about one-half their length). The end face of the swivel tip 116 on each swivel-tip screw 114 is then attached by any appropriate method (e.g., welded, glued, or inserted into matching alignment holes, and so on) to the back face 120 of the pressure plate 112 such that the back face of the pressure plate is parallel to the interior-facing side of the distal end wall 28 of the receiver tube interface section 34. The swivel-tip screws 114 are then backed out by simultaneously rotating them in a retraction direction until the pressure plate 112 is in contact with the interior facing side of the distal end wall 28 of the receiver tube interface section 34. This backed-out position is the position that the pressure plate 112 is placed in prior to attaching the hitch pin mechanism 10 onto the exterior of the receiver tube of the hitch. It is noted that the swivel tip 116 of each swivel tip screw 114 stays in place on the pressure plate 112 as the threaded portion 118 of the screw is rotated. When the hitch pin mechanism 10 is installed on the exterior of the receiver tube, the swivel-tip screws 114 are rotated simultaneously in an insertion direction to extend the pressure plate 112 into the interior of the receiver tube interface section 34 and against the side of the received tube until an appropriate amount of pressure has been placed against the receiver tube to hold the hitch pin mechanism in place on the receiver tube. In a variation of the hitch pin mechanism 10 implementation shown in FIG. 15, a single swivel-tip screw 114 is employed instead of two, as shown in FIG. 16. The single swivel-tip screw variation eliminates the need to rotate swivel-tip screws simultaneously as in implementations with multiple swivel-tip screws (such as shown in FIG. 15).

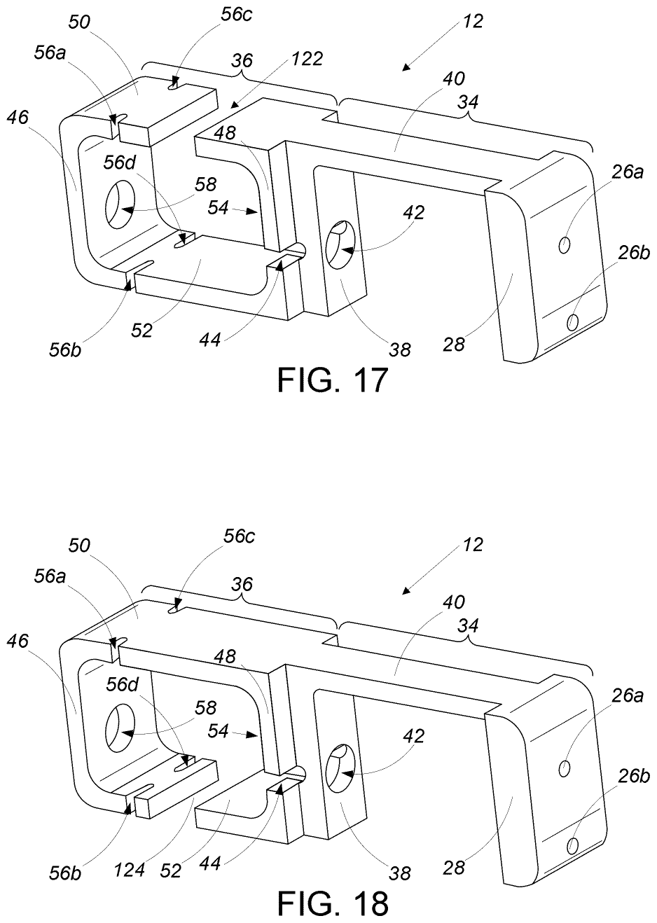

In one alternate implementation of the hitch pin housing section 36 of the mounting bracket 12 implementation depicted in FIGS. 2A-B, a portion of either the upper or lower, longitudinally-oriented, side walls 50, 52 is removed to reduce the weight of the mounting bracket. For example, as shown in FIG. 17, a section 122 of the upper side wall 50 has been removed, and as shown in FIG. 18, a section 124 of the lower side wall 52 has been removed.

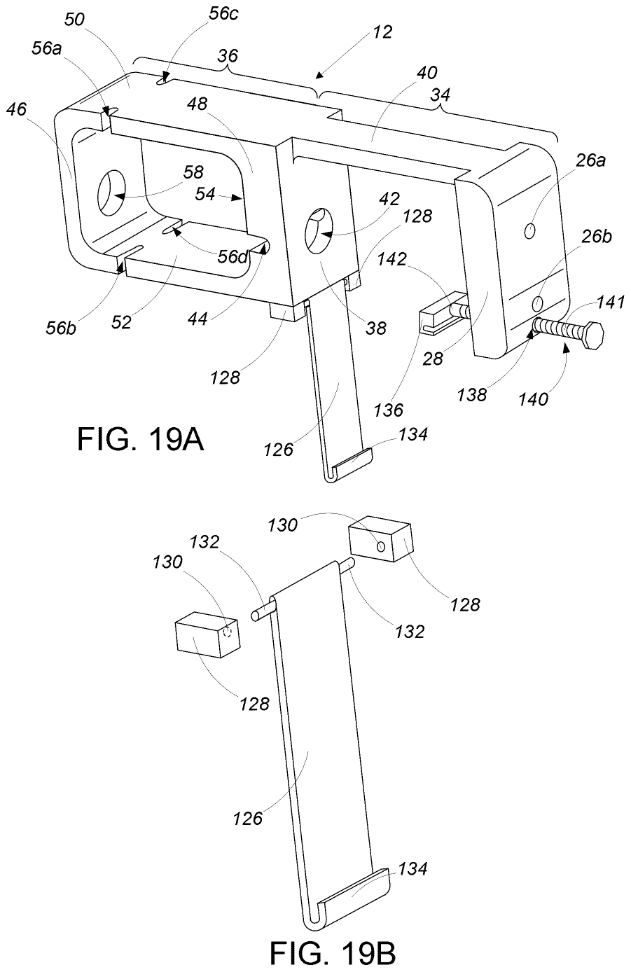

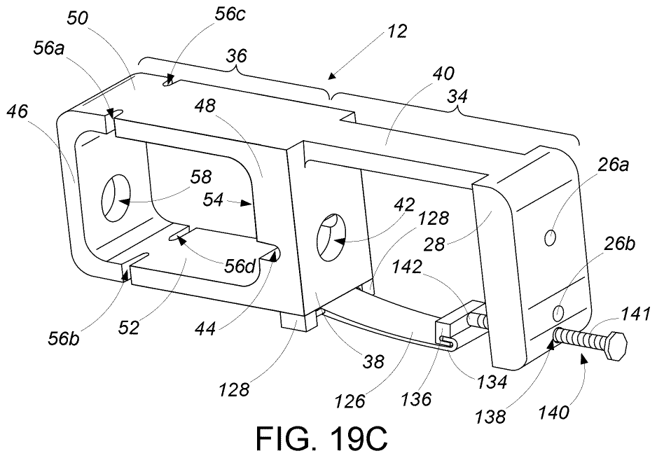

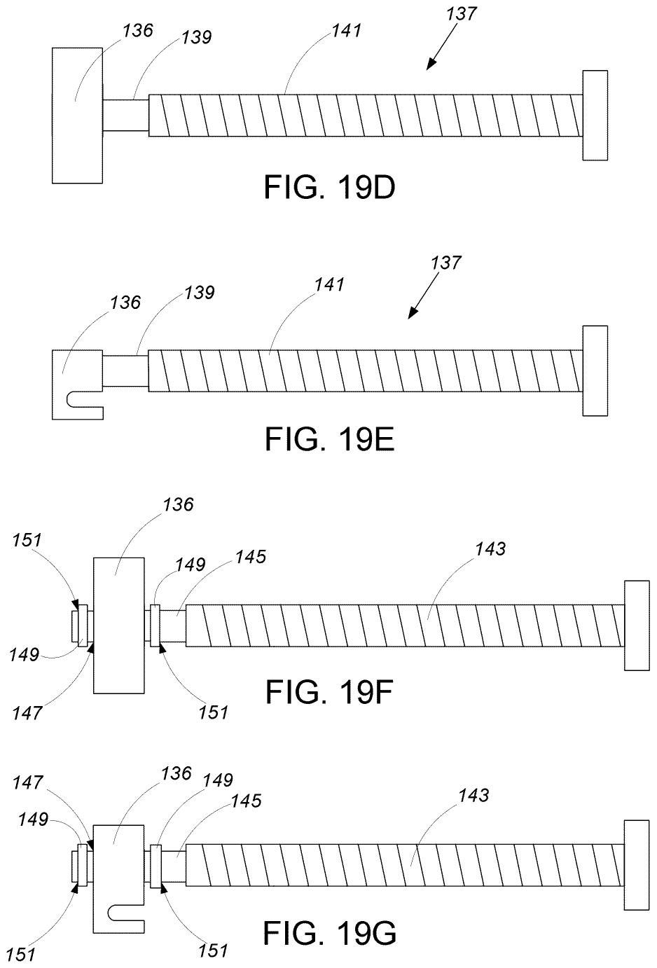

As described previously, the mounting bracket can be made from a variety of materials using a variety of manufacturing methods. However, no matter what material the mounting bracket is made from, the side wall of the receiver tube interface section must be stiff enough to resist flexing under the bending force applied to it when the pin hitch mechanism is installed on the receiver tube of a hitch and the threaded bolts are tightened down in order to prevent the hitch pin mechanism from coming loose from the receiver tube. In one implementation of the hitch pin mechanism, shown in FIGS. 3A-B, a reinforcing sleeve 80 was incorporated to minimize the flexing of the side wall 40 of the receiver tube interface section 34 when the threaded bolts are tightened down on the receiver tube of a hitch. In one alternate implementation, rather than using a reinforcing sleeve, a hinged strap 126 is employed as shown in FIGS. 19A-G to resist flexing of the side wall 40 of the receiver tube interface section 34 when the pin hitch mechanism is installed on the receiver tube of a hitch and the threaded bolts 24 are tightened down on the tube. In one version, the hinged strap 126 is made of a strong, stiff material (such as steel, stainless steel, and so on). More particularly, the depth of the proximal end wall 38 of the receiver tube interface section 34 depicted in FIGS. 2A-B is expanded to match the width of the proximal end wall 28 of the receiver tube interface section, as shown in FIG. 19A. In addition, a pair of hinge blocks 128 extend down from the bottom of the proximal end wall 38. The hinge blocks 128 are separated by a distance approximately equal to the depth of the side wall 40 of the receiver tube interface section 34. There is also a laterally-oriented blind hole 130 extending into each hinge block 128 from a centrally located point on the interior facing sides of the hinge block, as shown in FIG. 19B. The hinged strap 126 has a rectangular shape as seen in FIG. 19B and is approximately the same width as the depth of the side wall 40 of the receiver tube interface section 34. In addition, the hinged strap 126 has cylindrical rods 132 extending laterally from each side of its proximal end, as shown in FIG. 19B. Each of the rods 132 has a diameter such that when the rods are inserted into the respective blind holes 130 of the hinge blocks as shown in FIG. 19A, it forms a sliding fit allowing the hinged strap 126 to rotate. The distal end 134 of the hinged strap 126 is hooked laterally as shown in FIG. 19A. This hooked distal end 134 of the hinged strap 126 interfaces with a hooked receiver 136 that is extend-ably attached to the distal end wall 28 of the of the receiver tube interface section 34. More particularly, the version of the distal end wall 28 of the receiver tube interface section 34 depicted in FIGS. 2A-B is modified in this alternate implementation of the hitch pin mechanism such that extends further downward as shown in FIG. 19A. A longitudinally-oriented threaded through hole 138 is located toward the bottom of the distal end wall 28. The threaded through hole 138 is approximately in alignment with a horizontal plane containing the blind holes 130 of the hinge blocks 128. A receiver screw 140 that has a threaded proximal section 141, and a non-threaded distal section 142, is threaded through the threaded through hole 138 such that the non-threaded distal section 142 extends into the interior of the receiver tube interface section 34. A receiving attachment structure (e.g., the aforementioned hooked receiver 136 shown in FIG. 19A) interfaces with the non-threaded distal section 142 (in ways that will be described in more detail in paragraphs to follow) such that whenever the threaded proximal section 141 of the receiver screw 140 is rotated, the receiving attachment structure extends or retracts from the interior of the receiver tube interface section 34 depending on which direction the threaded proximal end of the receiver screw is rotated, but the receiving attachment structure does not rotate when it is attached to the aforementioned hinged strap 126 (as shown in FIG. 19C). Referring again to FIG. 19A, in operation, the hinged strap 126 is initially disengaged from the hooked receiver 136 and rotated such that it extends perpendicularly from the receiver tube interface section 34. This is the open position. The hitch pin mechanism is then installed onto the exterior of the receiver tube of a hitch in any of the variety of orientations shown in FIGS. 7A-D. Referring now to FIG. 19C, once the hitch pin mechanism is installed on the receiver tube, hinged strap 126 is rotated such that it encloses the receiver tube inside receiver tube interface section 34. The receiver screw 140 is initially screwed outward such that the hooked receiver 136 is adjacent to or touching the interior facing surface of the distal end wall 28 of the of the receiver tube interface section 34. This is the open position for the swivel-tip screw 140. With the hinged strap 126 rotated such that it encloses the receiver tube inside receiver tube interface section 34, the receiver screw 140 is screwed inward until the hooked receiver 136 lines up with the hooked distal end 134 of the hinged strap 126. The receiver screw 140 is then screwed outward to interface the hooked receiver 136 and hooked distal end 134 of the hinged strap 126 (i.e., hook them together). The receiver screw 140 is then screwed outward slightly further to tightly secure the hinged strap 126 in its closed position, as shown in FIG. 19C. In one version, the threaded bolts (24 in FIG. 1B) are then tightened against the side of the receiver tube as described previously to lock the hitch pin mechanism in place. However, in an alternate version, if the foregoing hinged strap assembly securely holds hitch pin mechanism on the receiver tube, the threaded bolts (24 in FIG. 1B) can be omitted. It is noted that the lateral width of the hinged strap 126 is made the same as the side wall 40 of the receiver tube interface section 34 for the same reason. Namely, this width is advantageous as it allows the side wall and the hinged strap to clear any structures that are often found on the top or bottom of the receiver tube of a hitch.

The receiver screw 140 can take any appropriate form as long as the non-threaded distal section 142 of the screw does not apply a rotational force on the receiver 136 when the threaded proximal section 141 of the screw is rotated in the manner described above. For example, in one version, the receiver screw is a swivel-tip screw 137 as depicted in FIGS. 19D-E. The swivel-tip screw 137 has a swivel-tip section 139 that is attached to the threaded proximal section 141 of the screw. The swivel-tip section 139 of the screw 137 rotates freely about a longitudinal axis of the screw independently from the threaded proximal section 141 of the screw. The distal end of the swivel-tip section 139 of the screw 137 is attached to the receiver 136 by any appropriate method (e.g., welded, glued, and so on). In an alternate version shown in FIGS. 19F-G, the receiver screw has a threaded proximal section 143 and a non-threaded distal section 145. The non-threaded distal section 145 is long enough to pass through a through hole 147 in the receiver 136 and accommodate a retaining washer 149 on each side of the receiver. More particularly, the non-threaded distal section 145 of the receiver screw has a laterally-oriented circumferential groove 151 cut into its surface near its distal end and at a location back from the distally-located groove that allow the receiver 136 to lie between the grooves 151 when installed on the receiver screw as shown in FIGS. 19F-G. Referring to FIGS. 19A and 19F-G, during assembly, with the threaded section 143 of the receiver screw threaded through the threaded through hole 138 at the bottom of the distal end wall 28 as described previously, a retaining washer 149 is press-fit onto the non-threaded distal section 145 of the receive screw and lodged into the more proximally-located groove 151. The receiver 136 is then installed on the non-threaded distal section 145 of the receiver screw 140 by passing the non-threaded distal section through the through hole 147 in the receiver 136 so that the hooked portion of the receiver faces outward as shown in FIGS. 19F-G. A second retaining washer 149 is then press-fit onto the non-threaded distal section 145 of the receiver screw 140 and lodged into the distally-located groove 151. The through hole 147 in the receiver 136 has a diameter that allows the non-threaded distal section 145 of the receiver screw 140 to freely rotate in the through hole 147 (e.g., a sliding fit). In this way, when the receiver 136 is connected to hooked distal end 134 of the hinged strap 126, and the receiver screw 140 is rotated, the receiver can be extended or retracted, but owing the non-threaded distal section 145 of the receiver screw 140 rotating within the receiver's through hole 147, the receiver will not impart any appreciable rotation force on the hinged strap 126.

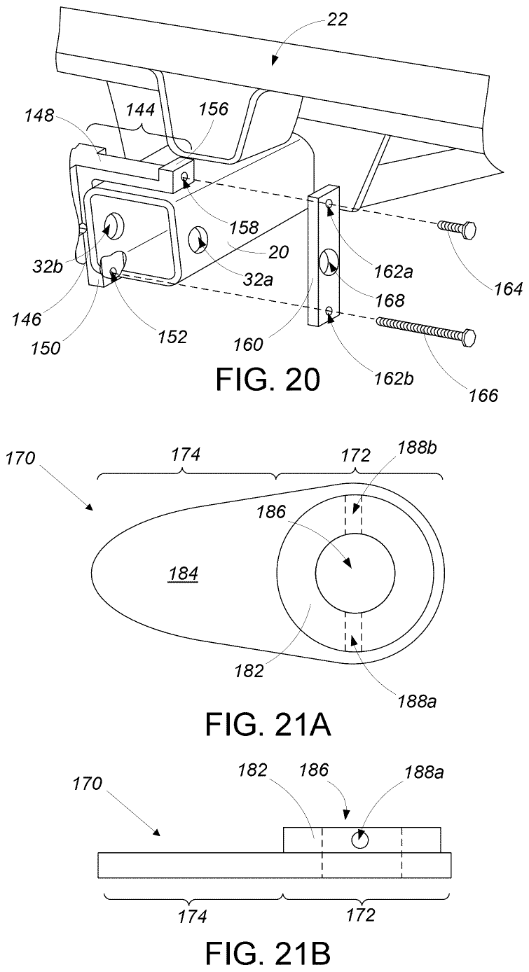

In one alternate implementation of the receiver tube interface section, the distal end wall is removed and a plate with a pair of bolts is added to secure the hitch pin mechanism to the receiver tube of a hitch. All the other features of the modified receiver tube interface section remain the same as described in connection with FIGS. 2A-B. More particularly, referring to FIG. 20, a modified receiver tube interface section 144 of the mounting bracket 12 has a laterally-oriented proximal end wall 146 that is attached at its upper end to a longitudinally-oriented side wall 148 and has a lower end 150 that extends below the bottom of the hitch pin housing section 36. The lower end 150 of the proximal end wall 146 that extends below the bottom of the hitch pin housing section 36 has a through hole 152 located midway across its width. The through hole 152 has a central axis that is parallel to the longitudinal axis of the hitch pin mechanism 10. The side wall 148 of the receiver tube interface section 144 extends longitudinally from the proximal end wall 146 to a point that is equal to or slightly less than the width of the smallest receiver tube 20 of the hitch 22 to which the hitch pin mechanism 10 will be attached. This distal end of the side wall 148 has a flange 156 that extends perpendicularly away from the receiver tube interface section 144. The flange 156 has a through hole 158 located midway across its width. It is noted that the width of the proximal end wall 146 of the receiver tube interface section 144 is the same as the width of the side wall 148 of the receiver tube interface section. As such, the axes of the through holes 152, 158 both lie on a longitudinally-oriented plane through the midline of the hitch pin mechanism 10. It is also noted that through holes 152, 158 may be threaded or not as will be explained shortly. A rectangular retaining plate 160 is used to secure the modified receiver tube interface section 144 of the hitch pin mechanism 10 to the receiver tube 20 of the hitch 22. The retaining plate 160 has a length that is approximately equal to the vertical distance between the distal tip of the flange 156 of the side wall 148 and the distal tip of the lower end 150 of the proximal end wall 146 of the modified receiver tube interface section 144. In addition, the retaining plate 160 has a width that is approximately equal to the width of the proximal end wall 146 and side wall 148 of the modified receiver tube interface section 144. The retaining plate 160 also has a pair of through holes 162a, 162b. One of the through holes 162a is located midway across the width of the retaining plate 160 near the top of the plate and the other through hole 162b is located midway across the width of the retaining plate 160 near the bottom of the plate such that the retaining plate through holes 162a, 162b line up with the through holes 152, 158 of the modified receiver tube interface section 144, respectively. Still further, the retaining plate 160 has a centrally-located hitch pin through hole 168 that allows the distal end of the hitch pin to extend through the hitch pin through holes 32a, 32b of the receiver tube 20 and then through the hitch pin through hole 168 of the retaining plate. This ensures the hitch pin can be fully extended regardless of the width of the receiver tube 20. The retaining plate 160 is made of a strong, stiff material (such as steel, stainless steel, and so on). In operation, the hitch pin mechanism 10 is installed onto the exterior of the receiver tube 20 of a hitch 22 in any of the variety of orientations shown in FIGS. 7A-D. Once the hitch pin mechanism 10 is installed on the receiver tube 20, the retaining plate 160 is placed against the side of the receiver tube 20 with the retaining plate through holes 162a, 162b lined up with the through holes 152,158 of the modified receiver tube interface section 144, respectively. A first, shorter threaded bolt 164 is inserted through the retaining plate's through hole 162a and into the modified receiver tube interface section's through hole 158. In one version, the modified receiver tube interface section's through hole 158 is threaded to match the shorter bolt 164. In this version, the shorter bolt 164 is threaded into and through the modified receiver tube interface section's through hole 158 until the shorter bolt holds the retaining plate 160 against the receiver tube 20. A second, longer threaded bolt 166 is inserted through the retaining plate's through hole 162b and into the modified receiver tube interface section's through hole 152. In one version, the modified receiver tube interface section's through hole 152 is threaded to match the longer bolt 166. In this version, the longer bolt 166 is threaded into and through the modified receiver tube interface section's through hole 152 until the longer bolt holds the retaining plate 160 against the receiver tube 20. The shorter and longer bolts 164, 166 are then tightened to secure the hitch pin mechanism to the receiver tube 20. In another version, the modified receiver tube interface section's through holes 152, 158 are not threaded, but have a diameter that is just large enough to allow the shorter and longer bolts 166, 164 to pass though the through holes 152, 158, respectively. In this alternate version, nuts (not shown) with threads matching the bolts 164, 166 are respectively placed at the backside of the through holes 152, 158 and the bolts 166, 164 are threaded through the nuts instead.

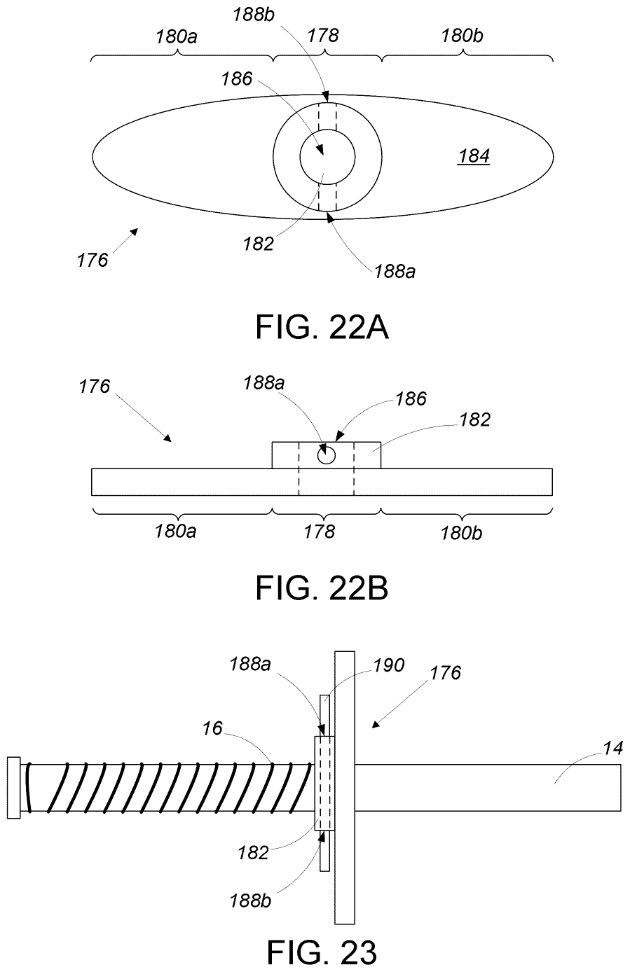

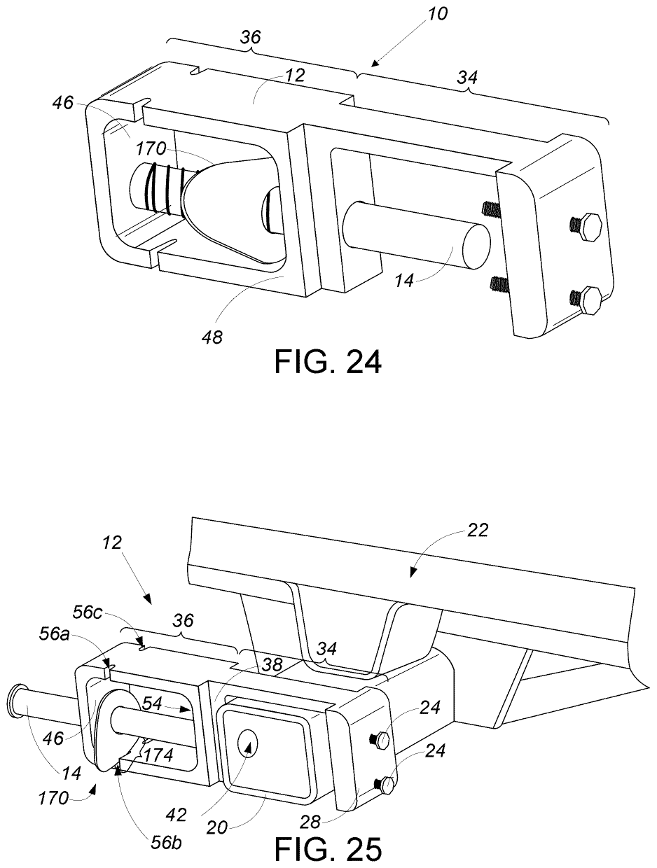

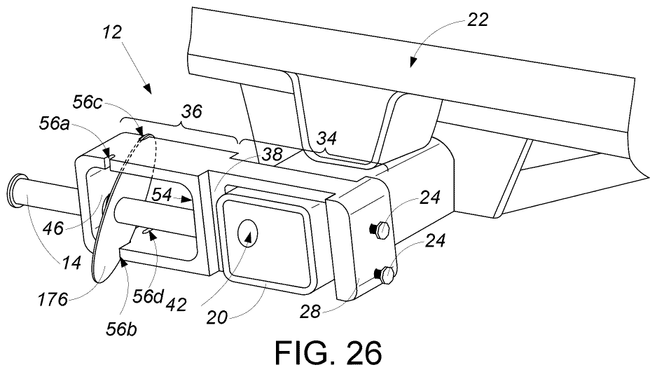

In one alternate implementation of the hitch pin retainer 18, rather than it being a crook-shaped cylindrical rod with a shank section 64 and a finger handle portion 68 as shown in FIG. 6, the hitch pin retainer takes the form of a single or double lobed disk cam. More particularly, in one implementation, a single lobe disk cam hitch pin retainer 170 is employed and is illustrated FIGS. 21A-B. FIG. 21A is a back view of the single lobe disk cam hitch pin retainer 170 and FIG. 20B is a side view of the retainer. As can be seen in FIGS. 21A-B, the single lobe disk cam hitch pin retainer 170 has a circular cam portion 172 with a single lobe portion 174 extending radially away from one side. With regard to the double lobe disk cam hitch pin retainer 176, one implementation of this retainer is illustrated FIGS. 22A-B. FIG. 22A is a back view of the double lobe disk cam hitch pin retainer 176 and FIG. 21B is a side view of the retainer. As can be seen in FIGS. 22A-B, the double lobe disk cam hitch pin retainer 176 has a circular cam portion 178 with a two lobes 180a, 180b extending radially away from opposing sides of the circular cam portion. Both versions of the retainer 170, 176 have a circular flange 182 that extends out from its back face 184. The cam portion 172, 178 and flange 182 have an axial hub 186 that has a diameter which forms a sliding fit with the hitch pin. In addition, the flange 182 has an outer diameter that forms a back-facing surface that one end of the hitch pin spring contacts. The longitudinal thickness of the flange 182 allows for a pair of opposing through holes 188a, 188b to be formed in the wall of the flange. The through holes 188a, 188b line up with the hitch pin's retainer through hole (66 in FIG. 4) when the disk cam hitch pin retainer 170 or 176 is installed on the hitch pin. Referring to FIG. 23, the double lobe disk cam hitch pin retainer 176 is shown installed on the hitch pin 14 in front of the hitch pin spring 16. A retaining pin 190 is inserted through the through holes 188a, 188b of the flange 182 and the hitch pin's retainer through hole to install the disk cam hitch pin retainer 176 onto the hitch pin. To this end, the diameters of the flange's through holes 188a, 188b and the hitch pin's retainer through hole are chosen so that the retaining pin 190 can be readily installed and removed by a user. For example, a siding fit or locational clearance fit can be employed. Additionally, the retaining pin 190 is long enough to extend out of both sides of the flange's through holes 188a, 188b a distance that facilitates its removal. It is noted that in an alternate version, the flange's through holes are threaded and the retaining pin is a threaded set screw that is threaded into or out of the flange's through holes. Although not shown, the single lobe disk cam hitch pin retainer is installed on the hitch pin in the same way as the double lobe disk cam hitch pin retainer. It is noted that the location of the hitch pin's retainer through hole (66 in FIG. 4) is further from the distal end of the hitch pin (14 in FIG. 4) than implementations using the previously described crook-shaped hitch pin retainer (18 in FIG. 6). More particularly, in the context of implementations employing the single disk cam hitch pin retainer 170, the location of the hitch pin's retainer through hole (66 in FIG. 4) is made such that when the hitch pin mechanism 10 is in its fully extended position, the front face of the single disk cam hitch pin retainer 170 is almost touching the proximal end wall 48 of the hitch pin housing section 36 as shown in FIG. 24. Although not shown, the front face of the double disk cam hitch pin retainer would also almost touch the proximal end wall of the hitch pin housing section when the hitch pin mechanism is in its fully extended position. When the hitch pin mechanism 10 is in its fully retracted position, as shown in FIGS. 25 and 26, the edge of the disk cam hitch pin retainer 170 or 176 is aligned with the hitch pin retainer retraction notches 56a-d. The notches 56a-d are made wide enough to allow the edge of the lobe portion 174 or 180a, 180b of the disk cam hitch pin retainer 170 or 176 to be inserted into the notch (as seen in FIG. 25 where the lobe portion 174 is inserted into notch 56b). Each of the hitch pin retainer retraction notches 56a-d is also located a sufficient longitudinal distance from the distal end wall 46 of the hitch pin housing section 36 such that whenever the lobe portion 174 or 180a, 180b of the disk cam hitch pin retainer 170 or 176 is installed in one of the notches, the hitch pin 14 is retracted to a position where its distal end is flush with the surface of the proximal end wall 38 of the receiver tube interface section 34 that faces the distal end wall 28 or is located within the hitch pin through holes 54, 42. The hitch pin retainer retraction notches 56a-d are indentions or a cut-outs, and can be configured with ninety-degree corners, or obtuse, or acute angles for securing the edge of the lobe portion 174 or 180a, 180b of the disk cam hitch pin retainer 170 or 176. It is also noted that since the location of the hitch pin's retainer through hole (66 in FIG. 4) is further from the distal end of the hitch pin (14 in FIG. 4), the hitch pin spring (16 in FIG. 5) may need to be shorter when compressed to compensate for the new location, as well as possibly being stronger to compensate for the reduced length of the spring. In the version of the disk cam hitch pin retainer 170 having one lobe portion 174 as shown in FIG. 25, the edge of the lobe portion can be secured in either retainer retraction notch 56b (as shown) or in retainer retraction notch 56a. This is accomplished by a user grabbing onto the lobe portion 174 of the disk cam hitch pin retainer 170 with their fingers and sliding the hitch pin 14 back until the lobe portion is aligned with the hitch pin retainer retraction notches 56a or 56b. The user then rotates the hitch pin 14 using the lobe portion 174 of the disk cam hitch pin retainer 170 until the edge of the lobe portion is secured in one of the hitch pin retainer retraction notches 56a or 56b. However, the lobe portion 174 of the single lobe disk cam hitch pin retainer 170 will not allow the hitch pin to be rotated such the edge of the lobe portion can be secured in either retainer retraction notch 56c or retainer retraction notch 56d. Thus, if the hitch pin mechanism 10 is to be installed in one of the orientation shown in FIGS. 7A-D that would require the lobe portion 174 of the single lobe disk cam hitch pin retainer 170 to be on the side of the mechanism with retainer retraction notches 56c and 56d, the hitch pin 14 would need to be removed and reoriented. This can be accomplished by pulling the retaining pin (190 in FIG. 23) out of the flange's through holes (188a, 188b in FIG. 23) and the hitch pin's retainer through hole to free the single lobe disk cam hitch pin retainer 170 to slide along the hitch pin 14, sliding the hitch pin back until it clears the hitch pin through holes 42, 54 and then further back enough to slide the single lobe disk cam hitch pin retainer 170 off the hitch pin. The single lobe disk cam hitch pin retainer 170 is then reinstalled onto the hitch pin as described previously except with the lobe portion 174 pointing out of the side of the hitch pin mechanism 10 having retainer retraction notches 56c and 56d, and the hitch pin is slid forward into the hitch pin through holes 42, 54. However, as shown in FIG. 26, in the version of the disk cam hitch pin retainer 176 having two lobe portions 180a, 180b, the edge of one of the lobe portions 180a can be secured in either retainer retraction notch 56b (as shown) or in retainer retraction notch 56a on one side of the hitch pin mechanism 10 and the edge of the other lobe portion 180b can be secured in either retainer retraction notch 56c (as shown) or in retainer retraction notch 56d on the other side of the hitch pin mechanism 10. This is accomplished by a user grabbing onto the lobe portion 180a of the disk cam hitch pin retainer 176 on the side of the hitch pin mechanism 10 facing them and sliding the hitch pin 14 back until the lobe portion is aligned with the hitch pin retainer retraction notches on that side of the mechanism. The user then rotates the hitch pin 14 using the lobe portion 180a of the disk cam hitch pin retainer 176 that they are holding until the edge of the lobe portion is secured in one of the hitch pin retainer retraction notches on that side of the mechanism. At the same time, the user's actions will secure the edge of the other lobe portion 180b in the hitch pin retainer retraction notch on the other side of the hitch pin mechanism 10 that is located diagonally from the hitch pin retainer retraction notch the first lobe portion 180a is secured into on the side of the hitch pin mechanism facing the user. It is noted that since the double lobe disk cam hitch pin retainer 176 is held in two retainer retraction notches (one on either side of the hitch pin mechanism), this version of the hitch pin retainer provides additional security in holding the hitch pin in the retracted position. It is also noted that the hitch pin retainer slot (44 in FIGS. 2A-B) is not necessary and is eliminated as can be seen in FIGS. 24-26.

It is also noted that any or all of the aforementioned implementations throughout the description may be used in any combination desired to form additional hybrid implementations. In addition, although the hitch pin mechanism implementations have been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims. In regard to the various functions performed by the above described components and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

Wherefore, what is

1. A hitch pin mechanism that releasably attaches to a receiver tube of a hitch and which releasably couples the hitch to a secondary receiver hitch, comprising:
a mounting bracket comprising:
a receiver tube interface section comprising proximal and distal end walls each of which is connected at one side by a side wall to form a structure with an open interior, said receiver tube interface section being sized to facilitate installation onto the exterior of the receiver tube of the hitch such that the side wall of the receiver tube interface section is disposed adjacent an upper or lower surface of the receiver tube and a pair of coaxial through holes in opposing sidewalls of the receiver tube are coaxially aligned with a hitch pin through hole in the proximal end wall of the receiver tube interface section; and
a hitch pin housing section comprising proximal and distal end walls each of which is connected at one side by a first side wall and at the other side to a second side wall to form a structure with an open interior, said proximal and distal end walls of the hitch pin housing section each having a coaxial hitch pin through hole that is also coaxial with the hitch pin through hole in the proximal end wall of the receiver tube interface section; and
a hitch pin comprising a distal portion and a proximal portion which is installed in the mounting bracket such that the hitch pin extends distal end first through the coaxial hitch pin through hole of the distal end wall of the hitch pin housing section and at least partially through a passage formed by the coaxial hitch pin through hole of the proximal end wall of the hitch pin housing section and the coaxial hitch pin through hole in the proximal end wall of the receiver tube interface section, wherein whenever the hitch pin mechanism is in a retracted position, the distal end of the hitch pin is prevented from extending into the open interior of the receiver tube interface section via a hitch pin retainer that is attached to the proximal portion of the hitch pin and comprises a restraint section which is held within a hitch pin retainer retraction notch formed in the first or second side wall of the hitch pin housing section, and wherein whenever the hitch pin mechanism is in an extended position, the distal end of the hitch pin extends into the open interior of the receiver tube interface section a distance sufficient for the distal portion of the hitch pin to extend through the pair of coaxial through holes in the opposing sidewalls of the receiver tube whenever the receiver tube interface section is installed on the receiver tube.

2. The hitch pin mechanism of claim 1, further comprising an attachment apparatus that releasably attaches the receiver tube interface section of the mounting bracket to the receiver tube of the hitch such that the side wall of the receiver tube interface section is disposed adjacent the upper or lower surface of the receiver tube and the pair of coaxial through holes in opposing sidewalls of the receiver tube are coaxially aligned with the hitch pin through hole in the proximal end wall of the receiver tube interface section.

3. The hitch pin mechanism of claim 2, wherein the attachment apparatus comprises:
a pair of threaded through holes in the distal end wall of the receiver tube interface section of the mounting bracket which are each located midway across a width of the distal end wall of the receiver tube interface section and offset from each other a sufficient distance that whenever the hitch pin mechanism is installed on the receiver tube of the hitch, the axes of the threaded through holes in the distal end wall of the receiver tube interface section are directed to respective locations on either side of the hitch pin through hole in the side of the receiver tube adjacent the distal end wall of the receiver tube interface section; and
a pair of threaded bolts, each of which is threaded through a different one of the pair of threaded through holes in the distal end wall of the receiver tube interface section with the bolt head on the exterior of the receiver tube interface section and a distal end of the bolt resident in the open interior of the receiver tube interface section, the distal end of each the threaded bolts being capable of being screwed up against a different one of said respective locations on either side of the hitch pin through hole in the side of the receiver tube whenever the hitch pin mechanism is installed on the receiver tube of the hitch.

4. The hitch pin mechanism of claim 2, wherein the attachment apparatus comprises:
a pair of threaded through holes in the distal end wall of the receiver tube interface section of the mounting bracket which are each located midway across a width of the distal end wall of the receiver tube interface section and offset from each other a sufficient distance that whenever the hitch pin mechanism is installed on the receiver tube of the hitch, the axes of the threaded through holes in the distal end wall of the receiver tube interface section are directed to respective locations on either side of the hitch pin through hole in the side of the receiver tube adjacent the distal end wall of the receiver tube interface section;
a rectangular pressure plate having a length no longer than the vertical length of an interior facing side of the distal end wall of the receiver tube interface section and a width no wider than the horizontal width of the interior facing side of the distal end wall of the receiver tube interface section; and
a pair of threaded swivel-tip screws, each of which is threaded through a different one of the pair of threaded through holes in the distal end wall of the receiver tube interface section with the head of the screws on the exterior of the receiver tube interface section and a swivel tip distal end of the screws resident in the open interior of the receiver tube interface section and attached to a back side of the pressure plate such that whenever the threaded swivel-tip screws are simultaneously rotated in an insertion direction a front side of the pressure plate is screwed up against a side of the receiver tube whenever the hitch pin mechanism is installed on the receiver tube of the hitch, and whenever the threaded swivel-tip screws are simultaneously rotated in a retraction direction the front side of the pressure plate is moved away from the side of the receiver tube.

5. The hitch pin mechanism of claim 2, wherein the attachment apparatus comprises a rectangular retaining plate forming the distal end wall of the receiver tube interface section, a first threaded bolt and a second threaded bolt, and wherein the retaining plate comprises a first through hole located midway across the width of the retaining plate adjacent the top edge of the retaining plate and a second through hole located midway across the width of the retaining plate adjacent the bottom edge of the retaining plate, wherein the retaining plate is connected to the side wall of the receiver tube interface section by the first threaded bolt which extends distal end first through an exterior facing side of the first through hole of the retaining plate and into a through hole of a flange that extends perpendicularly outwards from the end of the side wall adjacent the distal end wall of the receiver tube interface section, and wherein whenever the receiver tube interface section is installed on the receiver tube, the retaining plate is connected to the proximal end wall of the receiver tube interface section by the second threaded bolt which extends distal end first through an exterior facing side of the second through hole of the retaining plate and into a through hole located adjacent a bottom end of the proximal end wall.

6. The hitch pin mechanism of claim 1, wherein the mounting bracket further comprises a hitch pin retainer slot that acts as a guide channel for the hitch pin retainer whenever the hitch pin mechanism is in an extended position.

7. The hitch pin mechanism of claim 6, wherein the mounting bracket further comprises a second hitch pin retainer slot that acts as an alternate guide channel for the hitch pin retainer whenever the hitch pin mechanism is in an extended position, said second hitch pin retainer slot being formed into a second exterior facing surface of the mounting bracket that is opposite an exterior facing surface of the mounting bracket into which the first hitch pin retainer slot is formed.

8. The hitch pin mechanism of claim 1, wherein a first hitch pin retainer retraction notch is formed in an exterior facing edge of the first side wall of the hitch pin housing section, and a second hitch pin retainer retraction notch is formed in an exterior facing edge of the second side wall of the hitch pin housing section.

9. The hitch pin mechanism of claim 8, wherein a third hitch pin retainer retraction notch is formed in an exterior facing edge of the first side wall of the hitch pin housing section on a second exterior facing surface of the mounting bracket that is opposite an exterior facing surface into which the first and second hitch pin retainer retraction notches are formed, and a fourth hitch pin retainer retraction notch is formed in an exterior facing edge of the second side wall of the hitch pin housing section on the second exterior facing surface of the mounting bracket that is opposite the exterior facing surface into which the first and second hitch pin retainer retraction notches are formed.

10. The hitch pin mechanism of claim 9, wherein each of the hitch pin retainer retraction notches is located a sufficient distance from the distal end wall of the hitch pin housing section such that whenever the restraint portion of the hitch pin retainer is installed in one of the notches, the hitch pin is retracted to a position where its distal end is flush with the surface of the proximal end wall of the receiver tube interface section that faces the distal end wall of the receiver tube interface section or is located within the passage formed by the coaxial hitch pin through hole of the proximal end wall of the hitch pin housing section and the coaxial hitch pin through hole in the proximal end wall of the receiver tube interface section.

11. The hitch pin mechanism of claim 1, wherein the receiver tube of the hitch is rectangular with an upper-facing top, a lower-facing bottom, a right facing side, and a left facing side, and wherein the hitch pin mechanism is installed on the receiver tube in one of four ways comprising:
the hitch pin housing section is located adjacent the right side of the receiver tube, and the side wall of the receiver tube interface section is located on the top of the receiver tube; or
the hitch pin housing section is located adjacent the left side of the receiver tube, and the side wall of the receiver tube interface section is located on the top of the receiver tube; or
the hitch pin housing section is located adjacent the left side of the receiver tube, and the side wall of the receiver tube interface section is located on the bottom of the receiver tube; or
the hitch pin housing section is located adjacent the right side of the receiver tube, and the side wall of the receiver tube interface section is located on the bottom of the receiver tube.

12. The hitch pin mechanism of claim 1, wherein the hitch pin is cylindrical and comprises a head piece located at its proximal end that is larger than the through hole located in the distal end wall of the hitch pin housing section, and wherein whenever the hitch pin mechanism is in the extended position, the head piece buts against an exterior facing surface of the distal end wall of the hitch pin housing section of the mounting bracket, thereby preventing the distal portion of the hitch pin from extending further into the open interior of the receiver tube interface section of the mounting bracket.

13. The hitch pin mechanism of claim 1, wherein the hitch pin retainer is a cylindrical crook-shaped rod comprising a finger handle portion and a shank, said shank comprising the restraint section of the hitch pin retainer and having a diameter that allows the shank to be inserted and removed from a hitch pin retainer through hole located in the proximal portion of the hitch pin, and said finger handle portion being sized and shaped to allow a user to grasp the finger handle portion with their fingers and extend or retract the hitch pin using the hitch pin retainer.

14. The hitch pin mechanism of claim 13, wherein the hitch pin retainer through hole located in the proximal portion of the hitch pin is threaded and the shank of the hitch pin retainer comprises threads that mate with the threads of the hitch pin retainer through hole, and wherein the shank is inserted and removed from a hitch pin retainer through hole by rotating the shank.

15. The hitch pin mechanism of claim 1, wherein the hitch pin retainer is a single lobe disk cam comprising a circular cam portion having an axial hub through which the proximal portion of the hitch pin extends and which is removably attached to the proximal portion of the hitch pin, and a single lobe portion comprising the restraint section of the hitch pin retainer which extends radially away from one side of the circular cam portion a sufficient distance to allow a user to grasp the single lobe portion with their fingers and extend or retract or rotate the hitch pin using the hitch pin retainer and is long enough to allow an edge of the single lobe portion to interface with a hitch pin retainer retraction notch whenever the hitch pin mechanism is placed in the retracted position and the edge of the single lobe portion is rotated into the hitch pin retainer retraction notch.

16. The hitch pin mechanism of claim 1, wherein the hitch pin retainer is a double lobe disk cam comprising a circular cam portion having an axial hub through which the proximal portion of the hitch pin extends and which is removably attached to the proximal portion of the hitch pin, and two lobe portions comprising the restraint section of the hitch pin retainer, wherein a first of the lobe portions extends radially away from one side of the circular cam portion a sufficient distance to allow a user to grasp the single lobe portion with their fingers and extend or retract or rotate the hitch pin using the hitch pin retainer and is long enough to allow an edge of the first lobe portion to interface with a first hitch pin retainer retraction notch whenever the hitch pin mechanism is placed in the retracted position and the edge of the first lobe portion is rotated into the first hitch pin retainer retraction notch, and wherein the second of the lobe portions extends radially away from a side of the circular cam portion opposite the side of the circular cam portion from which the first lobe portion extends, said second lobe portion extending a sufficient distance to allow an edge of the second lobe portion to interface with a second hitch pin retainer retraction notch whenever the hitch pin mechanism is placed in the retracted position and the edge of the second lobe portion is rotated into the second hitch pin retainer retraction notch.

17. The hitch pin mechanism of claim 1, wherein the hitch pin further comprises a locking pin through hole located on the proximal portion of the hitch pin which whenever the hitch pin mechanism is in its extended position, the locking pin through hole clears the interior facing surface of the distal end wall of the hitch pin housing section, and wherein the hitch pin mechanism further comprises a removable locking pin that is installed in the locking pin through hole whenever the hitch pin mechanism is in its extended position and removed whenever the hitch pin mechanism is placed in its retracted position, said locking pin preventing the hitch pin from retracting out of the receiver tube interface section of the mounting bracket whenever it is installed.

18. The hitch pin mechanism of claim 17, wherein the removable locking pin is a push button locking pin with a key lock which comprises:
a locking pin shaft having a locking mechanism at its distal end which whenever activated with the locking pin shaft installed in the locking pin through hole prevents the locking pin shaft from being removed from the locking pin through hole, and which whenever deactivated allows the locking pin shaft to be removed from or installed into the locking pin through hole;
a push button disposed at a proximal end of the locking pin shaft, wherein whenever the push button is depressed when the locking pin shaft is installed in the locking pin through hole, the locking pin locking mechanism is activated; and
a key lock disposed at a proximal end of the locking pin shaft, which whenever the locking pin is activated and the key lock is unlocked using a key, the locking pin is deactivated.

19. The hitch pin mechanism of claim 1, wherein the receiver tube interface section of the mounting bracket further comprises a reinforcing sleeve that conforms to the shape of and is secured to the interior facing surfaces of the receiver tube interface section, said reinforcing sleeve being made of a strong, stiff material and has a thickness capable of minimizing flexing of the side wall of the receiver tube interface section whenever the receiver tube interface section is installed onto the exterior of the receiver tube of the hitch.

20. The hitch pin mechanism of claim 1, wherein the receiver tube interface section of the mounting bracket further comprises:
a rectangular hinged strap which rotates about a hinged end located adjacent an end of the proximal end wall of the receiver tube interface section that is opposite the end of the proximal end wall that is connected to the side wall of the receiver tube interface section, said hinged strap being rotatable from an open position wherein the hinged strap hangs from the hinged end in a way that it does not block an open side of the of the receiver tube interface section which allows the hitch pin mechanism to be installed onto the receiver tube of the hitch and a closed position wherein the hinged strap extends from the hinged end toward the end of the distal end wall of the receiver tube interface section that is opposite the end of the distal end wall that is connected to the side wall of the receiver tube interface section, and said hinged strap comprising an attachment structure located at an end of the hinged strap opposite the hinged end; and
a receiving apparatus comprising a partially threaded receiver screw that is threaded through a threaded through hole in the end of the distal end wall of the receiver tube interface section that is opposite the end of the distal end wall that is connected to the side wall of the receiver tube interface section such that a head of the receiver screw is located outside the receiver tube interface section and a non-threaded distal end of the screw is resident in the open interior of the receiver tube interface section and wherein the non-threaded distal end of the screw is attached to a receiving attachment structure that is in turn attachable to the attachment structure located at an end of the hinged strap opposite the hinged end of the hinged strap, and wherein the non-threaded distal end of the screw is attached to the receiving attachment structure in a manner that whenever a threaded proximal end of the receiver screw is rotated, the receiving attachment structure extends or retracts from the interior of the receiver tube interface section depending on which direction the threaded proximal end of the receiver screw is rotated, but the receiving attachment structure does not rotate; and wherein
in operation, the hinged strap is placed in the closed position with the attachment structure of the hinged strap attached to the receiving attachment structure of the receiving apparatus and the receiver screw is rotated in a retraction direction until the hinged strap is made taut.

21. A hitch pin mechanism that releasably attaches to a receiver tube of a hitch and which releasably couples the hitch to a secondary receiver hitch, comprising:
a mounting bracket comprising:
a receiver tube interface section comprising proximal and distal end walls each of which is connected at one side by a side wall to form a structure with an open interior, said receiver tube interface section being sized to facilitate installation onto the exterior of the receiver tube of the hitch such that the side wall of the receiver tube interface section is disposed adjacent an upper or lower surface of the receiver tube and a pair of coaxial through holes in opposing sidewalls of the receiver tube are coaxially aligned with a hitch pin through hole in the proximal end wall of the receiver tube interface section; and
a hitch pin housing section comprising proximal and distal end walls each of which is connected at one side by a first side wall and at the other side to a second side wall to form a structure with an open interior, said proximal and distal end walls of the hitch pin housing section each having a coaxial hitch pin through hole that is also coaxial with the hitch pin through hole in the proximal end wall of the receiver tube interface section;
a cylindrical hitch pin comprising a distal portion and a proximal portion which is installed in the mounting bracket such that the hitch pin extends distal end first through the coaxial hitch pin through hole of the distal end wall of the hitch pin housing section and at least partially through a passage formed by the coaxial hitch pin through hole of the proximal end wall of the hitch pin housing section and the coaxial hitch pin through hole in the proximal end wall of the receiver tube interface section, wherein whenever the hitch pin mechanism is in a retracted position, the distal end of the hitch pin is prevented from extending into the open interior of the receiver tube interface section via a hitch pin retainer that is attached to the proximal portion of the hitch pin and comprises a restraint section which is held within a hitch pin retainer retraction notch formed in the first or second side wall of the hitch pin housing section, and wherein whenever the hitch pin mechanism is in an extended position, the distal end of the hitch pin extends into the open interior of the receiver tube interface section a distance sufficient for the distal portion of the hitch pin to extend through the pair of coaxial through holes in the opposing sidewalls of the receiver tube whenever the receiver tube interface section is installed on the receiver tube; and
a cylindrical compression coil hitch pin spring that surrounds the exterior of the proximal portion of the hitch pin and which is capable of compressing to a length no more than the distance between an interior facing side of the distal end wall of the hitch pin housing section and the hitch pin retainer retraction notch, and to extend to a distance that is at least as long as the distance between the interior facing side of the distal end wall of the hitch pin housing section and the interior facing side of the proximal end wall of the hitch pin housing section, wherein whenever the hitch pin mechanism is in the retracted position, the hitch pin spring is compressed between the shank portion of the hitch pin retainer and the interior facing side of the distal end wall of the hitch pin housing section, and wherein whenever the restraint section of the hitch pin retainer is removed from the hitch pin retainer retraction notch when the hitch pin mechanism is in the retracted position, the hitch pin spring exerts a force on the hitch pin retainer which at least assists in pushing the hitch pin until the hitch pin mechanism is in the extended position.

22. A hitch pin mechanism that releasably attaches to a receiver tube of a hitch and which releasably couples the hitch to a secondary receiver hitch, comprising:
a mounting bracket comprising:
a receiver tube interface section comprising proximal and distal end walls each of which is connected at one side by a side wall to form a structure with an open interior, said receiver tube interface section being sized to facilitate installation onto the exterior of the receiver tube of the hitch such that the side wall of the receiver tube interface section is disposed adjacent an upper or lower surface of the receiver tube and a pair of coaxial through holes in opposing sidewalls of the receiver tube and a pair of coaxial through holes in opposing sidewalls of said secondary receiver hitch are coaxially aligned with a hitch pin through hole in the proximal end wall of the receiver tube interface section, and wherein at least one of the through holes in the opposing sidewalls of the receiver tube and said secondary receiver hitch is threaded; and
a hitch pin housing section comprising proximal and distal end walls each of which is connected at one side by a first side wall and at the other side to a second side wall to form a structure with an open interior, said proximal and distal end walls of the hitch pin housing section each having a coaxial hitch pin through hole that is also coaxial with the hitch pin through hole in the proximal end wall of the receiver tube interface section; and
a cylindrical hitch pin comprising a threaded distal portion with threads that mate with the threaded through hole or holes in opposing sidewalls of the receiver tube and a smooth proximal portion which is installed in the mounting bracket such that the hitch pin extends distal end first through the coaxial hitch pin through hole of the distal end wall of the hitch pin housing section and at least partially through a passage formed by the coaxial hitch pin through hole of the proximal end wall of the hitch pin housing section and the coaxial hitch pin through hole in the proximal end wall of the receiver tube interface section, wherein whenever the hitch pin mechanism is in a retracted position, the distal end of the hitch pin does not extend into the open interior of the receiver tube interface section, and wherein whenever the hitch pin mechanism is placed in an extended position, the distal end of the hitch pin is rotated so as to extend into the interior of the receiver tube interface section a distance sufficient for the distal portion of the hitch pin to extend through the coaxial through holes in the opposing sidewalls of the receiver tube and secondary receiver hitch whenever the receiver tube interface section is installed on the receiver tube.
